(19) United States
(12) Patent Application Publication
(10) Pub. No.: US 2025/0094244 A1
(43) Pub. Date: Mar. 20, 2025

(54) AUTOMATIC GRAPHICS PROCESSING UNIT SELECTION BASED ON KNOWN CONFIGURATION STATES

(71) Applicant: Nutanix, Inc., San Jose, CA (US)

(72) Inventors: Sven Kristian Huisman, Blaricum (NL); Cornelis Hendrikus Baggerman, Den Dolder (NL); David Andrew Brett, Liphook (GB)

(73) Assignee: Nutanix, Inc., San Jose, CA (US)

(21) Appl. No.: 18/969,027

(22) Filed: Dec. 4, 2024

Related U.S. Application Data
(63) Continuation-in-part of application No. 18/810,453, filed on Aug. 20, 2024.
Application No. 18/810,453 is a continuation of application No. 17/976,635, filed on Oct. 28, 2022, now Pat. No. 12,086,656.

(51) Int. Cl. G06F 9/54; G06F 9/455; G06F 9/50

(52) U.S. Cl. CPC G06F 9/54; G06F 9/45558; G06F 9/505; G06F 2009/4557; G06F 2009/45591

(57) ABSTRACT

Methods, systems, and computer program products for high-availability computing systems. A computer processor executes a sequence of instructions to execute, on a first node of a computing platform, a first instance of a computing process that is configured to use a first graphics processing unit (GPU) in a first GPU configuration. Responsive to detection of a loss of functionality that affects the first node, a second instance of the computing process is configured to be executed on the second node. The determination of aspects of the second node is made by (1) consulting a machine learned model to retrieve recommended known configuration states, then (2) mapping the recommended known configuration states onto one or more alternate second GPU configurations, and (3) configuring the second instance of the computing process to use the second GPU in one of the recommended known configuration states.

### RELATED APPLICATIONS

The present application is a continuation-in-part of, and claims the benefit of priority to co-pending U.S. patent application Ser. No. 18/810,453 titled “AUTOMATIC GRAPHICS PROCESSING UNIT SELECTION” filed on Aug. 20, 2024, which is a continuation of and claims the benefit of priority to U.S. patent application Ser. No. 17/976,635 titled “AUTOMATIC GRAPHICS PROCESSING UNIT SELECTION” filed on Oct. 28, 2022, (now U.S. Pat. No. 12,086,656) all of which are hereby incorporated by reference in their entirety.

### TECHNICAL FIELD

This disclosure relates to high availability computing systems, and more particularly to techniques for automatic graphics processing unit (GPU) selection.

### BACKGROUND

As time has progressed, computer users have become more and more accustomed to non-stop operation of their computing infrastructure. Users expect that frequently-occurring failures of the computing infrastructure (e.g., loss of a node or loss of a network socket) are automatically remediated without requiring user intervention. They expect that the remediation just happens, and often they expect the remediation to take place without any noticeable impact to the computing infrastructure responsiveness.

Concurrently, the scope of the aforementioned computing infrastructure and corresponding failure boundaries have expanded. Nowadays, computer users expect their primary system to be virtualized to the extent that entire applications and/or entire legions of users can be nearly transparently redeployed on so-called backup or secondary infrastructure. Such secondary infrastructure can come in the form of a “standby system,” or can come in the form of infrastructure provided by a cloud vendor. When an appropriate secondary computing infrastructure is available, it can be designated as a target for failover in the face of events that cause the primary system to lose some or all of its capabilities.

The designation of appropriate backup computing infrastructure—whether it be computing infrastructure such as the aforementioned “standby system,” or whether it be in the form of a cloud-provided infrastructure—becomes more and more complicated as the scope of the failure boundaries have expanded. Moreover, given the rapid adoption of cloud-based computing infrastructures, it comes about that there may be many hundreds of possible failover target configurations, each being configured with vendor-specific hardware offerings. As such, it becomes humanly impossible for a computer user or administrator to designate an appropriate backup computing infrastructure. This situation becomes more and more complicated as the number of users to be ‘restored’ becomes larger and larger—at least in that each user may be running widely different software applications that demand widely different hardware support (e.g., specialized hardware such as high-performance network interfaces and/or high-performance graphics processing units).

Unfortunately, legacy techniques for designating an appropriate backup computing infrastructure fail to account for the full range of specialized hardware support that is demanded by these software applications. Therefore, what is needed is a technique or techniques that provide high availability of a computing system even when specialized GPUs are demanded by processes of the computing system.

### SUMMARY

This summary is provided to introduce a selection of concepts that are further described elsewhere in the written description and in the figures. This summary is not intended to identify key features or essential features of the claimed subject matter, nor is it intended to limit the scope of the claimed subject matter. Moreover, the individual embodiments of this disclosure each have several innovative aspects, no single one of which is solely responsible for any particular desirable attribute or end result.

The present disclosure describes techniques used in systems, methods, and in computer program products for automatic graphics processing unit selection, which techniques advance the relevant technologies to address technological issues with legacy approaches. More specifically, the present disclosure describes techniques used in systems, methods, and in computer program products for reconfiguring a replacement graphics processing unit in disaster recovery scenarios. Certain embodiments are directed to technological solutions that dynamically reconfigures components of a virtualization system to account for variations between an initially allocated GPU and a replacement GPU when restarting on a recovery node.

The disclosed embodiments modify and improve over legacy approaches. In particular, the herein-disclosed techniques provide technical solutions that address the technical problems associated with providing high availability of a clustered virtualization system even when specialized GPUs are demanded by components of the to-be-restarted virtualization system. Such technical solutions involve specific implementations (e.g., data organization, data communication paths, module-to-module interrelationships, etc.) that relate to the software arts for improving computer functionality.

The ordered combination of steps of the embodiments serve in the context of practical applications that perform steps that dynamically reconfigure components of a virtualization system to account for variations between initially allocated GPUs and candidate replacement GPUs when restarting on a recovery node. As such, techniques that dynamically reconfigure components of a virtualization system to account for variations between an initially allocated GPU and a replacement GPU overcome heretofore unsolved technological problems that arise in the realm of computer systems. Specifically, problems associated with providing high availability of a clustered virtualization system (even when specialized GPUs are demanded by components of the to-be-restarted virtualization system) are solved by the techniques as disclosed herein.

Many of the herein-disclosed embodiments are able to dynamically reconfigure components of a virtualization system to account for variations between an initially allocated GPU and a replacement GPU are technological solutions pertaining to technological problems that arise in the hardware and software arts that underlie high availability computing systems. Aspects of the present disclosure achieve performance and other improvements in peripheral technical fields including, but not limited to, hyperconverged computing platform management and computing cluster management.

Some embodiments include a sequence of instructions that are stored on a non-transitory computer readable medium. Such a sequence of instructions, when stored in memory and executed by one or more processors, causes the one or more processors to perform a set of acts that dynamically reconfigure components of a virtualization system to account for variations between an initially allocated GPU and a replacement GPU (e.g., when restarting on a recovery node).

Some embodiments include the aforementioned sequence of instructions that are stored in a memory, which memory is interfaced to one or more processors such that the one or more processors can execute the sequence of instructions to cause the one or more processors to implement acts that account for variations between an initially allocated GPU and a replacement GPU.

In various embodiments, any combinations of any of the above can be organized to perform any variation of acts for reconfiguring a replacement graphics processing unit in disaster recovery scenarios, and many such combinations of aspects of the above elements are contemplated.

Further details of aspects, objectives and advantages of the technological embodiments are described herein, and in the figures and claims.

### BRIEF DESCRIPTION OF THE DRAWINGS

The drawings described below are for illustration purposes only. The drawings are not intended to limit the scope of the present disclosure.

FIG. 1A exemplifies GPU mapping failure scenarios.

FIG. 1B exemplifies GPU mapping success scenarios as used in systems that reconfigure a replacement GPU in disaster recovery scenarios, according to an embodiment.

FIG. 1C shows a failover handling system as used to reconfigure a replacement GPU in disaster recovery scenarios, according to an embodiment.

FIG. 1D1 depicts a system for training a machine learned model that is in turn used to map and configure a replacement GPU in disaster recovery scenarios, according to an embodiment.

FIG. 1D2 depicts a system for using a trained machine learned model in disaster recovery scenarios, according to an embodiment.

FIG. 1E1 depicts capture agents that capture data used for training a machine learned model that is in turn used to map and configure a replacement GPU in disaster recovery scenarios, according to an embodiment.

FIG. 1E2 depicts static and dynamic values that are used for training a machine learned model that is in turn used to map and configure a replacement GPU in disaster recovery scenarios, according to an embodiment.

FIG. 2 shows a GPU reconfiguration technique as used in systems that dynamically reconfigure a replacement GPU in accordance with a corresponding demand for GPU resources, according to an embodiment.

FIG. 3A1 depicts a first set of GPU reconfiguration modes as used in systems that dynamically reconfigure replacement GPUs in accordance with corresponding demands for GPU resources, according to an embodiment.

FIG. 3A2 depicts a second set of GPU reconfiguration modes as used in systems that dynamically reconfigure replacement GPUs in accordance with corresponding demands for GPU resources, according to an embodiment.

FIG. 4A depicts a first secondary computing infrastructure selection technique as used in systems that dynamically reconfigure replacement GPUs in accordance with computing process demands for GPU resources, according to an embodiment.

FIG. 4B depicts operations of a second secondary computing infrastructure selection technique as used in systems that dynamically reconfigure replacement GPUs in accordance with computing process demands for GPU resources, according to an embodiment.

FIG. 5A depicts a target cluster reconfiguration scenario as used in systems that dynamically reconfigure replacement GPUs in accordance with corresponding demands for GPU resources, according to an embodiment.

FIG. 5B depicts a process for creating a GPU resource recovery plan as used to dynamically reconfigure replacement GPUs in accordance with corresponding demands for GPU resources, according to an embodiment.

FIG. 5C depicts a user interface use model as used in combination with user-influenced selection of replacement GPUs, according to an embodiment.

FIG. 6 depicts a virtual machine GPU profile reconfiguration scenario as used in virtualization systems that dynamically reconfigure replacement GPUs in accordance with corresponding GPU demands from a virtual machine, according to an embodiment.

FIG. 7A depicts a sample GPU reconfiguration user interface as used in systems that provide user-defined reconfigurations of GPUs, according to an embodiment.

FIG. 7B depicts sample GPU mapping status indicators as used in systems that provide user-influenced reconfigurations of GPUs, according to an embodiment.

FIG. 7C depicts sample virtual GPU profile options as used in systems that provide user-defined reconfigurations of GPUs, according to an embodiment.

FIG. 8A, FIG. 8B, FIG. 8C, and FIG. 8D depict virtualization system architectures comprising collections of interconnected components suitable for implementing embodiments of the present disclosure and/or for use in the herein-described environments.

### DETAILED DESCRIPTION

Aspects of the present disclosure solve problems associated with using computer systems for providing high availability of a clustered virtualization system even when specialized GPUs are demanded by components of the to-be-restarted virtualization system. These problems are unique to, and may have been created by, various computer-implemented methods for providing high availability of a clustered virtualization system. Some embodiments are directed to approaches that dynamically reconfigures components of a virtualization system to account for variations between an initially allocated GPU and a replacement GPU when restarting on a recovery node. The accompanying figures and discussions herein present example environments, systems, methods, and computer program products for reconfiguring a replacement graphics processing unit in disaster recovery scenarios.

### Overview

Computing platforms (e.g., computing clusters) formed of heterogeneous nodes have become ubiquitous. Various nodes of various capabilities (e.g., size of memory, size and speed of attached storage, etc.) can be stitched together (e.g., via a networking backplane) such that the storage attached to each node is used to form a portion of a contiguous address space that all processors of all nodes can access using the same, common address space to access a storage pool. These sorts of computing platforms have the characteristic that addition of further node into the platform has the effect of adding resources in four dimensions: (1) additional memory (e.g., semiconductor main memory hosted on the added node), (2) additional storage capacity (e.g., number of gigabytes hosted on the added node), (3) additional networking bandwidth, and (4) additional processing resources.

This architecture is extremely flexible, at least in that processes can be easily migrated from one node to another (e.g., since the storage pool addressing is the same regardless of which node is accessing the storage pool). This easy migration has been a boon for high availability systems and high-performance systems. For example, if one node “goes down,” the computing processes that were executing on that node can be restarted on another node and/or across many other nodes.

Most processes are oblivious to or at least agnostic to variations between different CPU processors that might be present on any given node. However, the same cannot be said about graphics processors. Different graphics processors have vastly different characteristics. In some cases, a computing process that relies on a GPU might be very sensitive to the capabilities of the underlying GPU. In some cases, a computing process is based on code that has been handcrafted to run with a particular type of GPU. This then complicates the migration process. That is, when a computing process that relies on a particular type of GPU needs to be migrated to a different node, the existence of and capabilities of the GPU (if any) at the different node needs to be checked before migrating. In a naïve implementation, if the GPU at the different node is not the same type of GPU as is expected by the computing process, then the migration fails. This is a strongly unwanted outcome, especially in modern times when a computing cluster might host hundreds or thousands of processes that demand a GPU. Further, legacy techniques for designating an appropriate alternative (e.g., backup) computing infrastructure fail to consider the possibilities for restarting computing processes (e.g., virtual machines, containers, etc.) on the alternative computing infrastructure when the particular target computing infrastructure does not provide for exactly the same set of specialized hardware support that is demanded by certain functions of the computing processes (e.g., virtual machines, virtual desktop applications, etc.).

Addressing the foregoing deficiencies, especially as it pertains to providing recovery of virtual desktop applications, becomes complicated when one considers that certain specialized hardware (e.g., graphic processors) have literally hundreds of individually specifiable capabilities and/or parameters that can be used by said virtual desktop applications. What is needed is a way for a virtual desktop application that is configured to rely on the graphics processing capabilities of a primary computing cluster to be able to be restarted on a secondary computing cluster even though the graphics processing capabilities (e.g., GPUs or GPU configurations) of the secondary system are different from the graphics processing capabilities of the primary system.

An improved way would be to migrate to a target computing node that has a GPU, even if the GPU at the target node is somewhat different. For example, a computing process that is configured to use a GPU to capture a 4 kHD frame buffer might be able to run on a node that has a VGA frame buffer (albeit at a lower resolution). The herein-disclosed techniques involve matching a first set of GPU capabilities to a second set of GPU capabilities, If the second set of capabilities are at least sufficient to run the to-be-migrated computing process, then the computing process can be migrated. Using this technique, the GPUs on both nodes do not have to be the same or be in the same configuration. In fact, using the disclosed techniques, a GPU-hungry computing process can be migrated to a different node even if the GPU at the target node is (a) more capable than the GPU of the source node, or (b) less capable than the GPU of the source node.

Additionally or alternatively, one technique for determining a target node and/or configuring a target node involves retrieving one or more recommendations from a machine learned model. When used in a recommendation system mode, a machine learned model receives a set of conditions (e.g., then-current conditions) of the system and outputs one or more recommended candidate configurations, which recommended candidate configurations had been learned from prior observations, possibly including consideration of labels that had been applied to sets of such prior observations. Labels applied to or associated with labeled configurations can include indication of known-good configuration states and/or known-bad configuration states.

Additionally or alternatively, one technique for determining a target node and/or configuring a target node involves other uses of such a machine learned model as a predictor. Specifically, in addition to facilitating use of a machine learned model in a recommendation system mode, a machine learned model can be configured to be used as a predictor, where the predictor receives a set of conditions (e.g., then-current conditions) of the system or environment as a whole and outputs one or more candidate configurations, which candidate configurations had been learned from prior observations, and which candidate configurations had been classified into various sets of known configuration states.

As used herein, known configuration states refer to any set of GPU parameters and/or computing process parameters, and/or computing environment parameters, and/or any parameters pertaining to interactions between any pairs of the foregoing GPU parameters, computing process parameters, and computing environment parameters.

Any computing process and/or its agents can be configured for retrieving predictions from a machine learned model that includes any of the foregoing configuration states. Moreover, in situations where a computing process and/or its agents retrieving multiple predictions from said machine learned model the predictions can be applied to a corresponding domain. For example, if a prediction of a known-good configuration pertains to memory size, then an allocation and/or configuration of a memory can be based on memory-related aspects of the known-good configuration.

As such, the disclosure herein uses artificial intelligence (AI) to analyze the previous usage of the vGPUs bound to the virtual machine or computing processes. The AI entity, specifically an AI machine learned model, decides which vGPU configuration (e.g., vGPU profile, VGPU settings, etc.) in a target node or site should be assigned to the virtual machine or computing processes for running (e.g., in a failover scenario) at the target node or site.

The foregoing AI entity implements various forms of data-driven vGPU configuration selections by leveraging historical observed data (e.g., GPU resource consumption as observed at a primary data center). More specifically, some embodiments use an AI model that includes stored patterns of vGPU usage across various workloads. This model enables the system to predict the best-suited vGPU configuration for a secondary site which, in some cases, is a different node in the same data center. As time progresses, the AI continuously learns from the resource usage patterns, refining its recommendations to adapt to evolving workloads. This enables seamless disaster recovery.

As a consequence of a detected loss of functionality or some sort of a failover situation, the system automatically recommends and/or assigns an optimized configuration (e.g., a vGPU profile) on the recovery site, thus ensuring that the available hardware resources are utilized effectively while still ensuring that the computing workloads can continue with vGPU functionality. The AI-driven recommendation/assignment process is fully customizable, allowing administrators to either automate profile selection or choose to involve manual approvals.

By predicting the most efficient vGPU configuration, the system not only ensures a specified performance level and/or optimized performance level, but also mitigates unnecessary resource allocation, thus serving to manage costs in the recovery environment. To aid administrators, certain embodiments include a simulation feature, allowing administrators to pre-define vGPU configurations and simulate failovers. This enables testing and validation of AI-driven recommendations before actual disasters occur, thus improving preparedness and minimizing potential disruptions.

As is known in the art, legacy DR solutions rely on static vGPU configurations. Unfortunately, reliance on static configurations are deficient with respect to adapting to changing conditions (e.g., conditions that relate to dynamically-changing availability of hardware resources on or at the recovery site). The disclosed AI-based approach adapts to real-time conditions, thus improving over legacy methods by including data-driven decision-making (e.g., real-time condition-driven decision-making). This results in a more efficient and responsive DR process, particularly for graphics-intensive workloads.

Such adaptations with respect to real-time conditions enables dynamic adjustment of vGPU configurations on the recovery site. Moreover, since the system learns continuously by observing and capturing vGPU utilization patterns that corresponding to known configuration states (e.g., that correspond to or include known-good configurations states brought about by administrator-induced performance improvements), the system's recommendations improve continuously in a lock-step fashion. Further, the system learns continuously by observing and classifying known configuration states and how they may differ from previously observed patterns as well as how they may differ from (or be the same as) unwanted conditions such as performance degradation. The system labels such patterns as corresponding to known-good or alternatively, known-bad configurations. In use, this means that the system's recommendations improve continuously in the sense that it prefers recommending known-good configurations rather than recommending known-bad configurations. In some situations, (e.g., such as when the system is in an early training phase) it can happen that the only known configurations states are labeled as known-bad. In such situations the system may choose to overprovision resources at the target site.

Various embodiments operate in multi-cloud or hybrid cloud environments, thus improving scalability as well as cross-data center compatibility.

### Utilization Metrics

GPU utilization relates to the percent of time when kernels were using GPU. High GPU utilization suggests that the VM is using significant GPU resources, potentially indicating an intensive workload. Monitoring the GPU utilization will help in right-sizing the total capacity on the secondary location.

Encoder and decoder utilization relates to workloads that involve video playback, streaming, or any graphics-intensive operations, thus encoder and decoder utilization become key indicators. These metrics show the extent to which video encoding and decoding capabilities are used. High encoder or decoder utilization may suggest that the VM is handling heavy multimedia workloads. Codecs that are used by the virtual machine configuration on the primary location should be available in the secondary location for compatibility. For example, there are codecs used for encoding and decoding, like H.264, H.265, HEVC, AV1, VP8, VP9, and other (future) codecs. Encoding and decoding of these codecs can be offloaded to the GPU, so long as the physical GPU support the specific codec. By monitoring the usage of the codecs, good configurations can be learned. It should be understood that newer GPU models typically are capable of handling more encoding and decoding sessions than older GPU models. This encode and decode usage by the workloads are input into a machine learned model.

The historical usage of workloads can be monitored by keeping track of when a user was actually logged on to, for example, a virtual machine, and keeping track of how the user interacts with workloads that use the vGPU. Such user interaction data can be retrieved from multiple sources, such as from a desktop broker (e.g., Citrix), and/or from infrastructure components such as an active directory, and/or from an agent monitoring workload usage.

### Definitions and Use of Figures

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to “some embodiments” or “other embodiments” refer to a particular feature, structure, material, or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### Descriptions of Example Embodiments

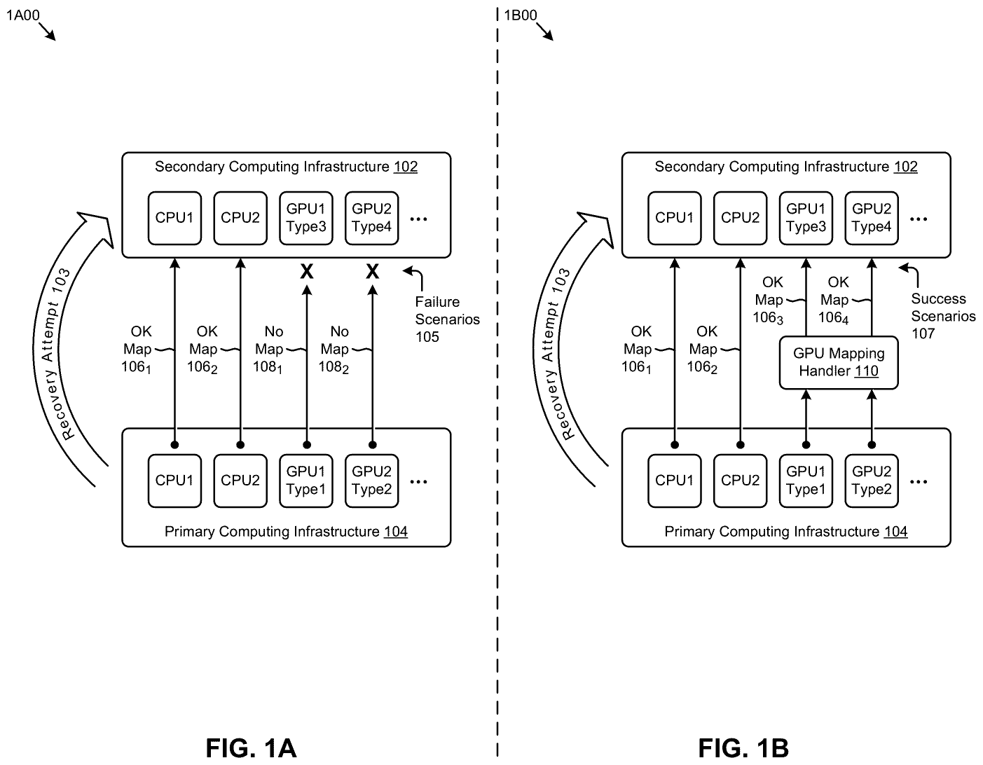

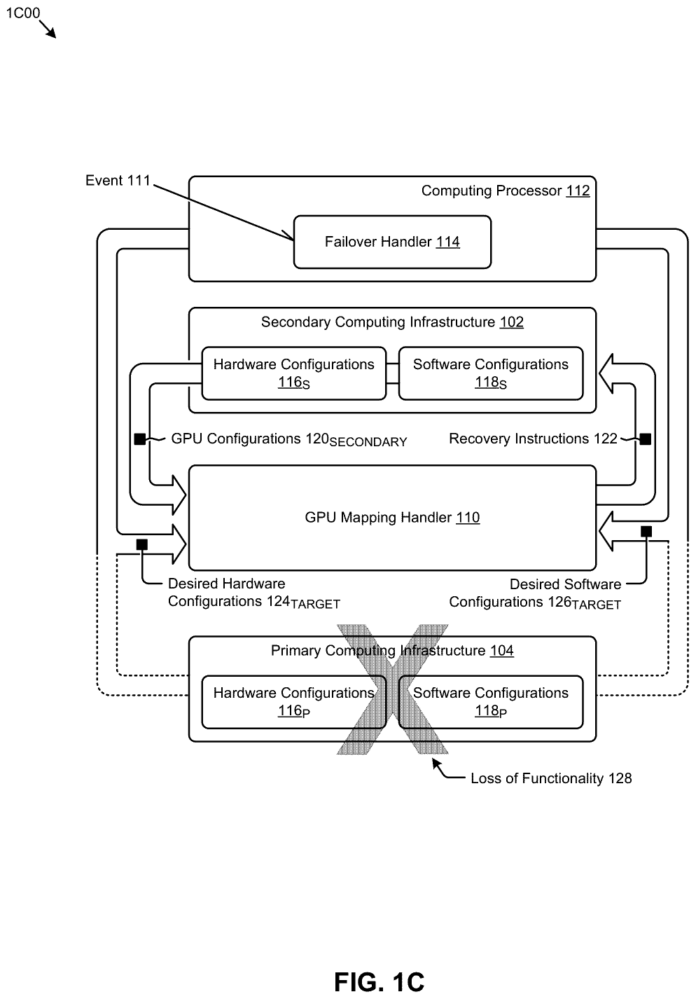

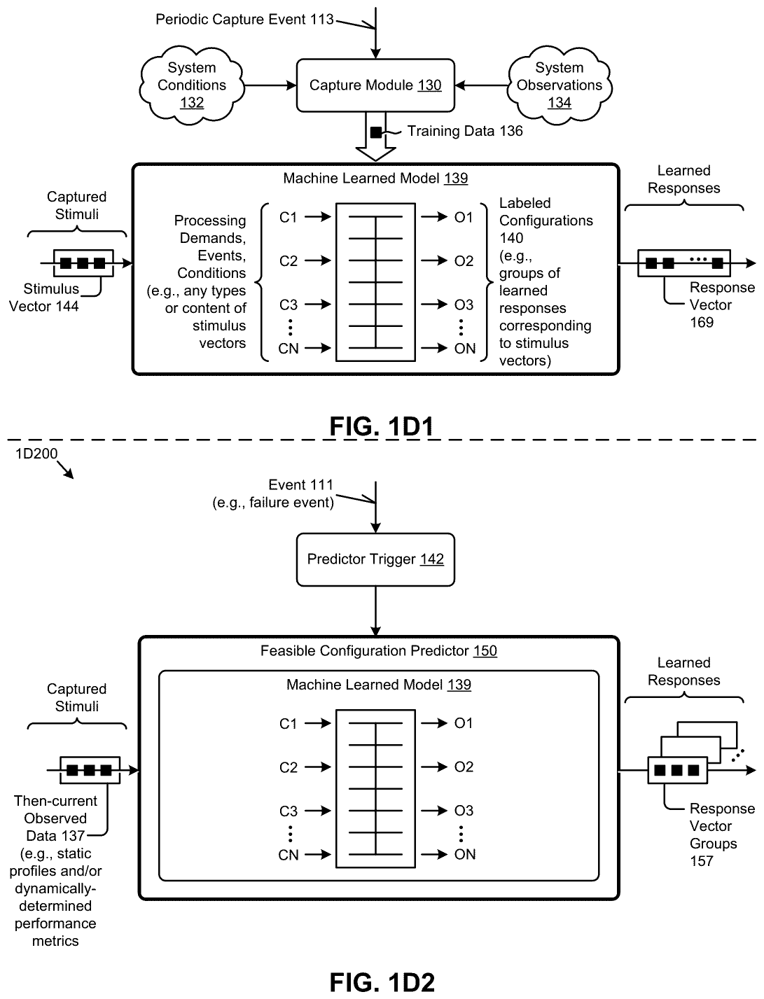

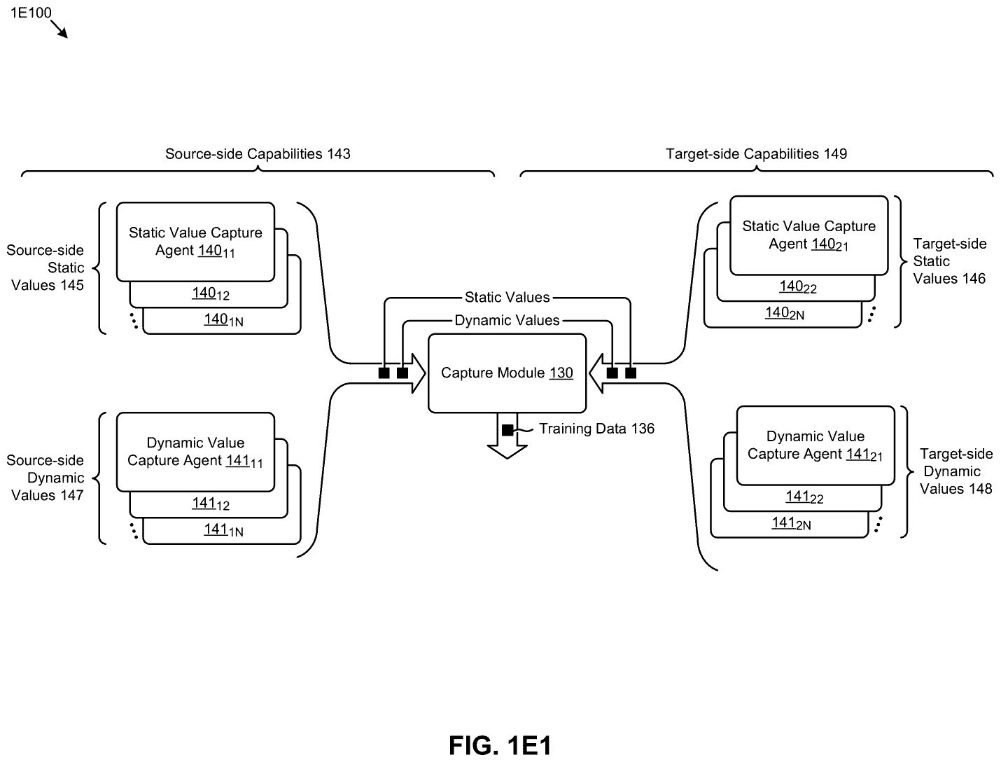

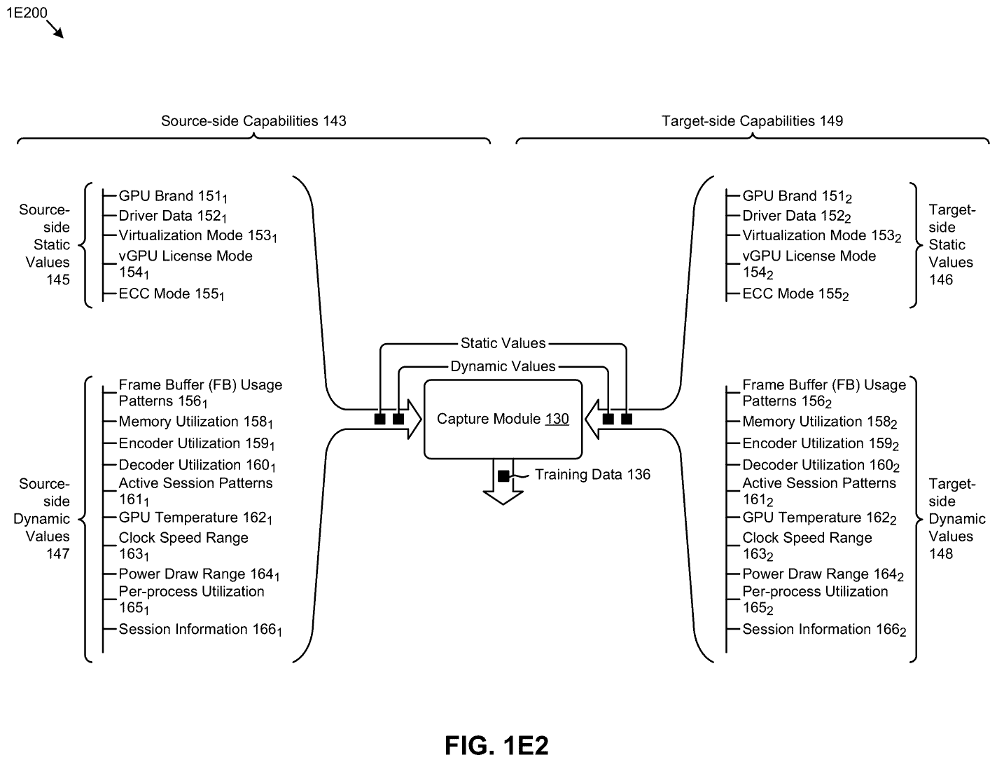

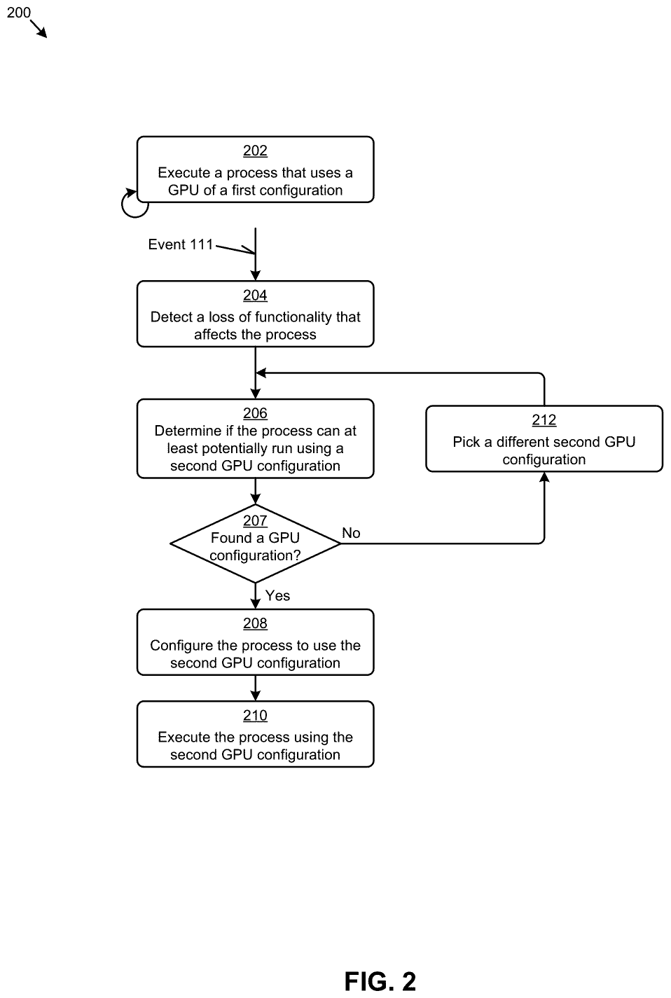

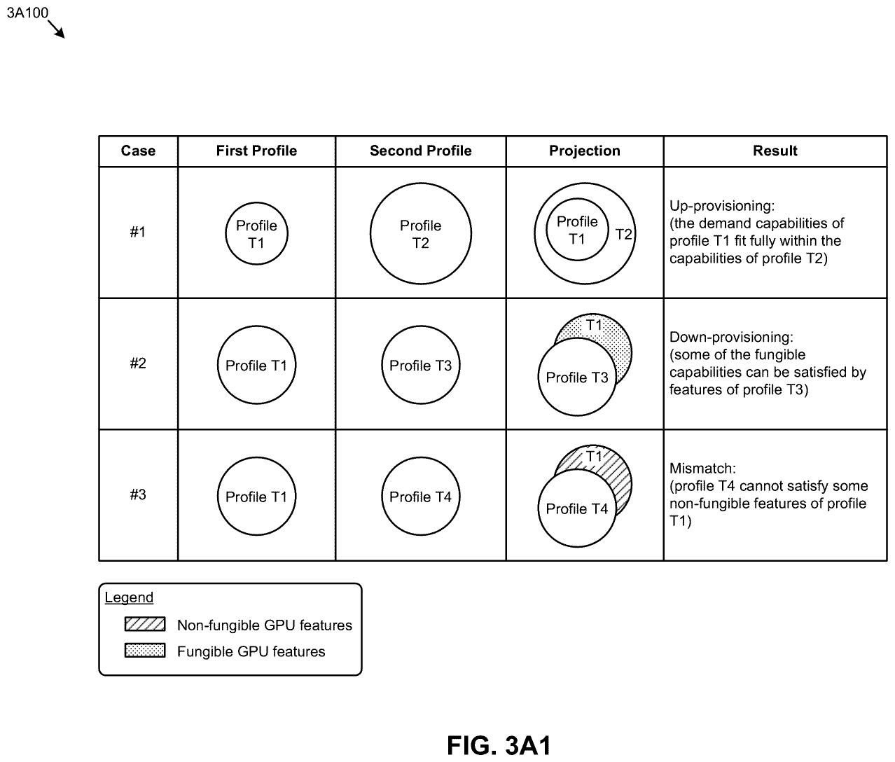

FIG. 1A exemplifies GPU mapping failure scenarios. As an option, one or more variations of GPU mapping failure scenario 1A00 or any aspect thereof may be implemented in the context of the architecture and functionality of the embodiments described herein and/or in any environment.

As shown, during a recovery attempt 103 the central processing units (CPUs) that were in use in the primary computing infrastructure 104 are mapped to CPUs of the secondary computing infrastructure 102. This is depicted by OK map 106₁ and OK map 106₂. In this example, CPU1 of the primary computing infrastructure is mapped to CPU1 of the secondary computing infrastructure, and CPU2 of the primary computing infrastructure is mapped to CPU2 of the secondary computing infrastructure. This is a typical case since CPUs of modern computing systems are very often both upwards and downwards compatible. However, the same cannot be said for GPUs. Often different GPUs correspond to very different sets of features and capabilities. This leads to an inability to directly map a GPU of (for example) type1 or type2 to a GPU of (for example) type3 or type4, respectively. This is shown as failure scenarios 105. Specifically, attempting to directly map a GPU of type3 to a GPU of type1 results in a no map 108₁, and attempting to directly map a GPU of type4 to a GPU of type2 results in a no map 108₂.

The legacy techniques of FIG. 1A are naïve. Improvements such as are disclosed hereunder improve over the legacy techniques in a manner that results in success scenarios 107.

FIG. 1B exemplifies GPU mapping success scenarios as used in systems that reconfigure a replacement GPU in disaster recovery scenarios. As an option, one or more variations of GPU mapping success scenario 1B00 or any aspect thereof may be implemented in the context of the architecture and functionality of the embodiments described herein and/or in any environment.

By applying the techniques disclosed herein, this mapping problem can be ameliorated or eliminated, such is depicted by success scenarios 107. Specifically, by implementing a GPU mapping handler 110 that implements some or all of the techniques disclosed herein, when attempting to a map a GPU of type3 to a GPU of type1, the GPU mapping handler reconciles GPU capabilities in a manner that results in the shown OK map 106₃. Similarly, attempting to map a GPU of type4 to a GPU of type2 results in OK map 106₄.

A GPU mapping handler can be implemented in any suitable location within the ecosystem of computing equipment. In some cases, a plurality of standby GPU mapping handlers can be implemented in a plurality of nodes and/or in a plurality of clusters and/or in a plurality of clouds. More specifically, a plurality of GPU mapping handlers can be implemented in multiple locations such that, upon detecting a loss of functionality that affects some particular computing process, or upon detecting a loss of functionality that affects some particular computing process, or upon detecting a loss of functionality that affects operation of or access to some particular computing infrastructure (e.g., an on-premises cluster or a cloud-based cluster), then a GPU mapping handler can operate from a location that is not experiencing the loss of functionality. One possible juxtaposition of a GPU mapping handler for operation within a disaster recovery scenario is shown and described as pertains to FIG. 1C.

FIG. 1C shows a failover handling system as used to reconfigure a replacement GPU in disaster recovery scenarios. As an option, one or more variations of failover handling system 1C00 or any aspect thereof may be implemented in the context of the architecture and functionality of the embodiments described herein and/or in any environment.

The figure is being presented to illustrate how a GPU mapping handler can be used to facilitate recovery operations in event of a disaster. In this particular scenario, the GPU mapping handler facilitates bring-up of the shown secondary computing infrastructure 102 upon detection of a loss of functionality 128 that affects primary computing infrastructure 104.

In the particular configuration of failover handling system 1C00, a failover handler 114 is situated within computing processes 112. Upon detecting an event 111 that corresponds to a loss of functionality 128 that affects primary computing infrastructure 104, the failover handler sends messages to an available instance of a GPU mapping handler. As shown, the messages include information about desired hardware configurations 124_{TARGET} as well as information about desired software configurations 126_{TARGET}. The desired hardware configurations and the desired software configurations might reflect the last known configuration states (i.e., before the loss of functionality that affected the primary computing infrastructure) of the primary computing infrastructure (e.g., hardware configurations 116_{P} or software configurations 118_{P}), or the desired hardware and software configurations might reflect a variation of the last known states of the primary computing infrastructure.

The GPU mapping handler is able to communicate with any one or more operational elements of a selected secondary computing infrastructure 102. In the example case as shown, the GPU handler is able to retrieve the full set of hardware and software configurations (e.g., hardware configurations 116_{S} and software configurations 118_{S}) of the secondary computing infrastructure. In some cases, the secondary computing infrastructure is a standby recovery platform and, as such, its then-current configuration might be identical or similar to the configuration of the primary computing infrastructure just prior to the loss of functionality. In other cases, the secondary computing infrastructure might not be predefined to be a recovery platform, in fact in some situations the secondary computing infrastructure might not be known until after detection of the loss of functionality. In such cases, the desired hardware configurations and the desired software configurations of the target would need to be analyzed with respect to available GPU configurations (e.g., GPU configurations 120_{SECONDARY}) of the target computing infrastructure. Moreover, the desired hardware configurations and the desired software configurations of the target can be provided to the target computing infrastructure as a portion of recovery instructions 122.

FIG. 1D1 depicts a system for training a machine learned model that is in turn used to map and configure a replacement GPU in disaster recovery scenarios. As an option, one or more variations of the system for training the machine learned model or any aspect thereof may be implemented in the context of the architecture and functionality of the embodiments described herein and/or in any environment.

As shown, any number of system conditions 132 can be captured, and any number of system observations 134 can also be captured. Captured conditions may themselves be (or pertain to) known configuration states that are specific to a particular GPU. Additionally or alternatively, captured conditions may themselves be (or pertain to) known configuration states that are specific to the computing environment that supports a particular GPU. Additionally or alternatively, captured conditions may themselves be (or pertain to) known configuration states that are specific to relationships and/or interactions between a particular GPU and its computing environment.

Furthermore, both static as well as dynamic values can be captured at any moment in time. Still further, periodic events (e.g., occurrences of periodic capture event 113) can be scheduled to occur on a preconfigured periodicity and/or at periodic times. In some cases, the timing to invoke capture module 130 can be determined dynamically—irrespective of any preconfigured event or other previous event. Strictly as examples, aspects of both static system configurations/conditions as well as dynamically-determined configurations/conditions can be captured and used in defining aspects of the machine learned model 139. Moreover, aspects of both static system configurations/conditions as well as dynamically-determined configurations/conditions can be captured and then used in, and/or applied to, and/or used to characterize any one or more labeled configurations 140.

### Static Configurations

Various static configurations have been introduced and described hereinabove. Strictly as examples, such static configurations may include: Which vGPU profiles are configured on which virtual machines? What frame buffer sizes are allocated? What is the total available number of vGPU profiles? What is the total number of virtual machines that are defined to have one or more vGPUs allocated. What are the applicable recovery requirements?

### Dynamically-Captured System Observations

Various performance metrics (e.g., GPU utilization) or other changing variables (e.g., storage headroom) can be monitored on an ongoing basis to capture a historical usage of a given vGPU and its environment. In some cases, the aforementioned historical usage (e.g., on the virtual machines) forms a pattern, which pattern can be labeled and used in training the machine learned model.

Captured patterns (e.g., static patterns, dynamic time-varying patterns, statistically-calculated patterns) may themselves be (or pertain to) known configuration states that are specific to a particular GPU. Additionally or alternatively, captured patterns may themselves be (or pertain to) known configuration states that are specific to the computing environment that supports a particular GPU. Additionally or alternatively, captured patterns may themselves be (or pertain to) known configuration states that are specific to relationships and/or interactions between a particular GPU and its computing environment.

In some cases, performance metrics and/or other changing variables might be captured at multiple locations (e.g., at a primary location and/or at a secondary location). In some situations, changing values and/or differences (e.g., as calculated over static or slowly-changing differences) can be captured as a scalar. In other situations, changing values and/or differences (e.g., such as when differences are calculated over dynamic, fast-changing differences) can be captured as waveforms.

### GPU Utilization

Strictly as illustrative examples, the foregoing performance metrics might include frame buffer (video memory) usage. For instance, a particular virtual machine might be preconfigured with a fixed amount of frame buffer memory (e.g., 1,2,4,8 GB amount of memory, or more or less). The frame buffer handles image and texture storage for rendering. Tracking this helps identify if the VM's graphical workload is demanding more storage for graphical data than the profile can support. Guardrails might be defined and used by the capture module. For instance, the frame buffer usage can be monitored by the capture module and an alert is issues in the event that the frame buffer usage is ever observed to exceed 90% (peak) or over 70% (on a time-adjusted average). If a particular frame buffer had been observed to be underutilized, then a configuration with a lower amount of frame buffer can be defined as a good candidate configuration. Such a candidate configuration and/or a variety of aspects pertaining to that configuration can go into the machine learned model 139. In turn, the aspects that are captured into the machine learned model might later be emitted (e.g., in a response vector 169 or portion thereof) by an instance of a machine learned model. Alternatively, if a particular frame buffer had been observed to be overutilized (e.g., frequently above 90% usage or a time-based average above 70%), then a larger configuration with more frame buffer space allocated to the VM might be deemed to be a good candidate configuration.

To still further explain, the foregoing GPU utilization might be calculated as the percentage of the time when kernels were using GPU. High GPU utilization values suggest that the VM is using significant GPU resources, potentially indicating an intensive workload. Monitoring the GPU utilization will help in right-sizing the total capacity on the secondary location. Moreover, by monitoring GPU utilization in actual in-situ situations, an appropriately down-sized (or up-sized) configuration can be learned.

### Encoder and Decoder Utilization

For workloads involving video playback, streaming, or any graphics-intensive operations, encoder and decoder utilization become key performance metrics. Such metrics show the extent to which video encoding and decoding capabilities are used. High encoder or decoder utilization may suggest that the VM is handling heavy multimedia workloads. Codecs that are used by the virtual machine configuration on the primary location should be available in the secondary location for compatibility. For example, there are codecs used for encoding and decoding, such as H.264, H.265, HEVC, AV1, VP8, VP9, and other (future) codecs. In some cases, encoding and decoding of these codecs can be offloaded to the GPU, however the preferred offload approach is when the physical GPU supports the specific codec(s) of interest. Newer GPU models typically are capable of handling more encoding and decoding sessions than older GPU models. This encode and decode usage of the virtual machines are input to the allocation options on the secondary site. Thus, by monitoring the usage of the codecs as well as changing ranges of allocation options that may arise in actual in-situ situations, an appropriately down-sized (or up-sized) configuration can be learned.

### Additional Observable Metrics

Ongoing usage of a virtual machine can be monitored by keeping track of when a user was actually logged on to the virtual machine and interacted with applications that used the vGPU. This data can originate from and be retrieved from multiple sources. As one example, infrastructure components such as Microsoft's Active Directory™ or one or more agents can monitor application usage across an infrastructure.

### Training of Machine Learned Models

Either or both unsupervised training and supervised training can be employed. Supervised training involves some human interaction to label response vectors (e.g., as known-good responses, or as known-bad responses or to label responses with a variable value over a wide dynamic range), whereas unsupervised training need not involve human interaction to label response vectors (e.g., as known-good responses, or as known-bad responses, or to label responses with a variable value over a wide dynamic range). It should be noted that labeling of response vectors as “bad” or “fail” may be just as determinative as would be labeling of response vectors as “good” or “pass”. That is, a model, especially in its early stage of being populated with stimulus and response vectors, might be of high value merely by predicting what configurations are indicative or what not to do (e.g., how not to provision resources at the target site). However, over time, a model, especially in its later stages of being populated with stimulus and response vectors, might output multiple known-good predictions based on longevity and/or proven accuracy of a particular response vector (or based on longevity and/or proven accuracy of a particular set of a plurality of response vectors).

Once at least some values have been populated into the machine learned model, the model can be used to predict know-good configurations that can then be considered when handling a disaster recovery (or other) scenario. One way for using a trained machine learned model to handle a disaster and disaster recovery scenario is shown and described as pertains to FIG. 1D2.

FIG. 1D2 depicts a system 1D200 for using a trained machine learned model in disaster recovery scenarios. As an option, one or more variations of system 1D200 or any aspect thereof may be implemented in the context of the architecture and functionality of the embodiments described herein and/or in any environment. In some variations, system 1D200 implement all or a portion of the foregoing GPU mapping handler.

The figure is being presented to illustrate how a machine learned model can be configured (e.g., wrapped) with additional software (and/or hardware as the case may be) to serve as a predictor. Specifically, and as shown, feasible configuration predictor 150 can be wrapped around machine learned model 139 such that (1) all or portions of then-current observed data 137 can be used to produce a stimulus vector 144 that is in turn used stimulate the machine learned model in a manner such that (2) the model produces one or more learned responses in the form of response vector groups 157. The response vector groups in turn can be analyzed by downstream processing so as to optimize or otherwise select a preferred configuration based on the learned (and labeled) responses that were observed to arise when identical or similar model stimulus was applied.

As shown, the embodiment of FIG. 1D2 includes a predictor trigger 142, which can be configured to respond to event 111 (e.g., a disaster-related event or possibly a migration-related event) by triggering application of a stimulus vector to the feasible configuration predictor 150 so as to cause the machine learned model to produce one or more response vector groups, which response vector groups include one or more machine-learned configurations of a target-side GPU configuration. In turn, the one or more machine-learned configurations of a target-side GPU configuration can be analyzed individually or as a group, and therefrom a preferred, possibly optimal configuration can be selected. Other operational components of the system can perform operations that bring the target-side into a state that substantially matches the selected configuration.

FIG. 1E1 depicts capture agents that capture data used for training a machine learned model that is in turn used to map and configure a replacement GPU in disaster recovery scenarios. As an option, one or more variations of system 1E100 or any aspect thereof may be implemented in the context of the architecture and functionality of the embodiments described herein and/or in any environment. In variations, system 1E100 implements all or a portion of the foregoing GPU mapping handler.

FIG. 1E1 is being presented to illustrate how various source side capabilities 143 as well as target side capabilities 149 can be captured using a combination of the shown capture module 130 and (optionally) a variety of autonomous capture agents. The captured values corresponding to the foregoing capabilities can be formatted into training data 136, which in turn is used to populate a machine learned training model.

As shown under the source side capabilities 143, a series of static value capture agents (e.g., static value capture agent 140₁₁, static value capture agent 140₂₁, static value capture agent 140₁₂, static value capture agent 140₂₂, . . . , static value capture agent 140_{1N}, static value capture agent 140_{2N}) as well as a series of dynamic value capture agents (e.g., dynamic value capture agent 141₁₁, dynamic value capture agent 141₂₁, dynamic value capture agent 141₁₂, dynamic value capture agent 141₂₂, . . . , dynamic value capture agent 141_{1N}, dynamic value capture agent 141_{2N}) operate concurrently.

These capture agents can operate over any period of time. Some values change relatively slowly (e.g., source-side static values 145 and/or target-side static values 146), whereas other values change relatively quickly (e.g., source-side dynamic variables 147 and/or target-side dynamic variables 148). In some cases, a capture agent is configured to capture one or more scalar values (e.g., source-side static values 145), whereas other capture agents are configured to capture waveforms or patterns (e.g., source-side dynamic variables 147) that emerge during the period(s) of observation. This sort of observation of changing values can happen asynchronously between a given source and a given target. It should be understood that the term source-side infrastructure refers to the infrastructure that suffers some sort of loss of functionality, whereas the term target-side infrastructure refers to infrastructure that can be used to implement disaster recovery remediation. Further, it should be noted that although only one target-side infrastructure is shown in FIG. 1E1, in actual practice there may be many independent target infrastructures.

The capture agents can capture and process any kind of infrastructure data, whether such data is considered to be static data or dynamic data. Capture of infrastructure data can and does go beyond capture of GPU data. That is, data capture and its use in a machine learned model is not limited to only GPU data. Examples of data that are known to be useful for making predictions of functionality of a candidate GPU configuration (e.g., based on a trained machine learned model) are shown and described as pertains to FIG. 1E2.

FIG. 1E2 depicts static and dynamic values that are used for training a machine learned model that is in turn used to map and configure a replacement GPU in disaster recovery scenarios. As an option, one or more variations of system 1E200 or any aspect thereof may be implemented in the context of the architecture and functionality of the embodiments described herein and/or in any environment. In variations, system 1E200 implements all or a portion of the foregoing GPU mapping handler.

The shown static and dynamic values are presented and discussed herein merely as illustrative examples. Capture of data other than the illustrative examples is contemplated. In fact, and as foreshadowed above, infrastructure data other than GPU data might be used to train a machine learned model, and it might be that a prediction of the functionality of a candidate GPU configuration is substantially based on infrastructure data other than GPU-specific data.

The machine learned model might include GPU data where the GPU is of a particular type or from a particular GPU vendor. For example, in the case where the GPU is an NVIDIA GPU, the model can be trained by capturing metrics using vendor-provided capabilities such as the NVIDIA-SMI tool. This tool or a tool provided by a different vendor can be used to capture static values (e.g., GPU settings) as well as dynamic values (e.g., performance metrics). These static values and dynamic values can be captured on any physical host that supports use of the foregoing NVIDIA-SMI tool. In some embodiments, agents are used to perform the static value and dynamic value capture. In some embodiments such agents are implemented as one or more virtual machines. Any combination of agents can train the model regarding the overall usage of any component of the infrastructure and/or any aspect of the environment. Strictly as an example, virtual machines that access the functionality of the foregoing NVIDIA-SMI tool can train the machine learned model using any GPU performance and/or utilization metric.

Examples of specific information as well as corresponding examples of how said specific information can be used in a machine learned predictor are now briefly discussed.

### Product Brand

Product brand (e.g., GPU brand 151₁ and GPU brand 151₂) can sometimes be used to predict a good versus bad configuration. In some cases, different brand GPUs as between the source-side infrastructure and a particular target-side infrastructure can result in a “bad” (e.g., possibly non-functional) configuration at the target. On the other hand, certain GPUs or GPU types are matched in terms of architecture, and thus, substitution of a different brand GPU when failing over from a source-side infrastructure to a target-side infrastructure might result in a “good” configuration.

### Driver Version

The information about the driver version can be used to find a good match on the recovery site. In many cases, the driver (e.g., driver data 152₁ and driver data 152₂) on the host must match the driver in the virtual machine to work correctly. Such information about the driver can be used to ensure that a predicted configuration comports with software dependencies within the VM workloads. As is known in the art, a mismatch of driver versions between sites often leads to significant instability or a failure to load critical applications. The historical stability of drivers can guide prediction and subsequent decision-making as pertains to the secondary site's configuration. In some cases, a particular driver version for a specific GPU is considered a configuration dependency.

### GPU Virtualization Mode (vGPU vs. Passthrough)

The choice between vGPU (virtual GPU) and passthrough modes (e.g., referred to herein as virtualization mode 153₁ and virtualization mode 153₂) affects the level of GPU sharing among VMs. A vGPU allows multiple VMs to share a single physical GPU by segmenting its resources, while passthrough assigns an entire GPU to a single VM. This mode is often used to determine the distribution of GPU resources across workloads. A mismatch between modes can be taken into consideration when calculating usage profiles of VMs. One known-good configuration of a GPU virtualization mode as between a source-side infrastructure and a target-side infrastructure involves configuring the recovery site to mirror the primary site's GPU virtualization mode.

### vGPU License Mode

The particular vGPU license mode (e.g., vGPU license mode 154₁ and vGPU license mode 154₂) chosen for a particular VM impacts the allocated frame buffer and GPU processing power. Configurations involving so-called “A” profiles are usually used on shared hosted desktop environments, whereas so-called “B” profiles are usually used in low to medium workload types (e.g., where only a 1 GB or 2 GB frame buffer is offered as an option). A so-called “Q” profile is usually used with heavier graphic workloads and can have larger frame buffer sizes. Strictly to illustrate, if a 2 GB “Q” profile is used, it's usually not recommended to use a 2 GB “B” profile, unless the actual utilization shows that a B profile is sufficient for the user that has a Q profile assigned. Observed utilization patterns can be used in conjunction with other information to comport with a given license mode. Historical frame buffer and GPU utilization data is used to recommend whether a lighter “B” profile could suffice in place of a heavier “Q” profile-yet without impacting performance.

### ECC Mode (Error-Correcting Code Mode)

The ECC mode (ECC mode 155₁ and ECC mode 155₂) impacts the reliability of data processed by the GPU, particularly in high-performance workloads or involving scientific workloads where data integrity is critical. Enabling ECC can slightly reduce overall GPU performance but prevents bit errors that may cause computational inaccuracies. The trained model can include ECC mode configurations in the recommendations. Moreover, the trained model could include using ECC-enabled GPUs at the recovery site for high-reliability workloads where fault tolerance is critical. In other scenarios, configuration of certain ECC modes can have a negative impact on performance, depending on the type of GPU or type of hypervisor in use. Matching the ECC mode between a particular GPU and other in-use infrastructure components is preferred when determining a recovery configuration.

### Frame Buffer Memory Usage

Frame buffer (FB) usage patterns (e.g., frame buffer usage patterns 156₁ and frame buffer usage patterns 156₂) can be used to aid in the determination of whether or not a preconfigured frame buffer allocation is appropriate or, alternatively, if adjustments are needed. Consistently high utilization (e.g., over 90% frequently or an average above 70%) suggests the need for a FB allocation upgrade at the recovery site. Conversely, if usage is low, reallocating a lower frame buffer amount can free up resources. This metric is particularly relevant for VMs handling high-resolution image processing or graphical workloads where under-allocation could bottleneck performance.

### Memory Utilization

Memory utilization (e.g., memory utilization 158₁ and memory utilization 158₂) can be used in a predictive model so as to provide insights into how often GPU memory is actively used by a particular workload in the VM. This metric informs the model about the memory needs of each VM and is essential in assessing whether the GPUs at the recovery site have sufficient capacity. VMs with consistently high memory usage may require GPUs with expanded memory at the secondary location to prevent memory-related bottlenecks, especially if multiple VMs are consolidated onto fewer GPUs.

### Encoder Utilization (%) and Decoder Utilization (%)

The encoder and decoder utilization rates (e.g., encoder utilization 159₁ and encoder utilization 159₂, decoder utilization 160₁ and decoder utilization 160₂) are useful indicators of how much video processing load each VM requires. VMs running video-intensive workloads, such as media editing or conferencing software, will have higher encoding/decoding utilization rates in these areas. Analyzing these metrics identifies the demand for encoding/decoding at the secondary site, ensuring that GPUs with similar or greater encoding/decoding capacities are available to maintain performance standards.

### Encoder Active Sessions and Average FPS

Tracking encoder sessions (e.g., active session patterns 161₁ and active session patterns 161₂) and the average frames per second (FPS) generated can help estimate the aggregate video processing capacity needed at the recovery site. For example, if the number of encoder sessions peak at certain times during the day (e.g., during regular business hours), the trained model can anticipate potential high-demand periods, thus helping to allocate GPU resources more dynamically based on these patterns. Ensuring that secondary GPUs can handle similar FPS demands prevents lag or delays in video-related applications.

### GPU Temperature

Temperature (e.g., GPU temperature 162₁ and GPU temperature 162₂) are sometimes important factors in determining how many VMs a GPU can support without throttling due to overheating. High GPU temperatures suggest that the secondary site should have adequate cooling or fewer high-demand VMs on each GPU to maintain stability. Monitoring temperature trends allows predictive allocation adjustments to reduce thermal load, ensuring that GPUs perform optimally even if the recovery site has a less efficient cooling infrastructure.

### Clock Speed Ranges (Graphics/SM/Memory/Video)

The clock speed ranges (e.g., clock speed range 163₁ and clock speed range 163₂) of the graphics core, and/or streaming multiprocessor (SM), and/or memory, and/or video subsystems affect the processing capability of the GPU. Matching these speeds between the source site and the recovery site serves to ensure that VMs do not experience reduced performance or unexpected behaviors. A trained predictive model can suggest clock speed configurations or alternative GPU models that deliver comparable performance metrics, thus facilitating flexibility in hardware choices even if an exact match is unavailable.

### Power Draw

The power draw metric (e.g., power draw range 164₁ and power draw range 164₂) represents the wattage required by each GPU under load. Comporting power draw ranges between a source site and a target site influences capacity planning at the target/recovery site. For example, the total power required by all GPUs at full load at the source site would be expected to fall within the target site's power budget. Capturing peak and average power draws, and using this data in making configuration predictions, improves the likelihood that the target site's power infrastructure can sustain the GPUs without risking outages.

### GPU Utilization Per Process

This metric (e.g., per-process utilization 165₁ and per-process utilization 165₂) identifies specific applications or processes within each VM that consume the most GPU resources. Tracking these patterns and populating such patterns into the machine learned model facilitates prediction as to which VMs or processes will demand the most GPU resources during recovery. Insights from this metric can inform whether additional or higher-spec GPUs are needed at the secondary site, thus helping to tailor resource allocation based on known usage profiles of critical applications.

### Session Information

Session information (e.g., session information 166₁ and session information 166₂) can be gathered from a broker (e.g., Citrix) with information about what display resolution is used in a given session. For example, HD video resolution is known to run on any profile that is capable of displaying 4K video. Additional session aspects include (1) how long has the session been active, (2) which applications are being used, and (3) at what times during a time period (e.g., a time period during a day) a session has been active and/or which applications are being used during those times.

Further information about the applications (e.g., collections of VMs) can be collected from the virtual machines as well as from their respective brokers.

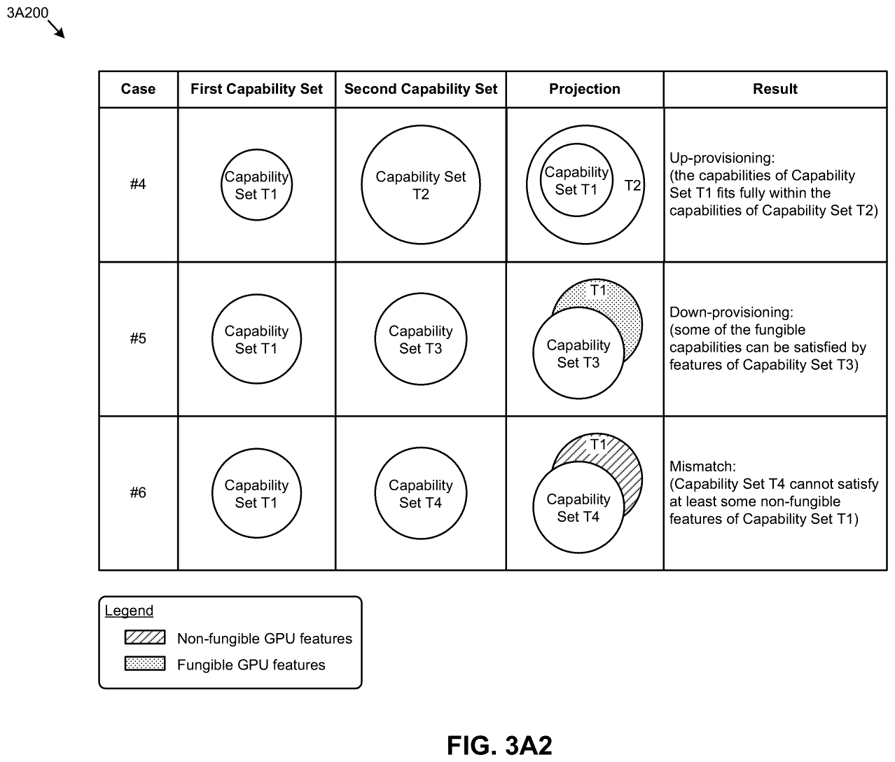

As heretofore mentioned, legacy techniques exhibit many mapping failure modes, for example, when the available GPU configurations at the target did not exactly match the GPU configurations of the source. These strongly undesirable failure modes are ameliorated or eliminated by application of flexible GPU reconfiguration techniques that handle cases when GPU configurations at the target do not exactly match GPU configurations of the source. One such flexible technique is shown and described as pertains to FIG. 2.

FIG. 2 shows a GPU reconfiguration technique as used in systems that dynamically reconfigure a replacement GPU in accordance with a corresponding demand for GPU resources. As an option, one or more variations of GPU reconfiguration technique 200 or any aspect thereof may be implemented in the context of the architecture and functionality of the embodiments described herein and/or in any environment.

This figure is being presented to illustrate one way to transition from ongoing execution of a first computing process using a first GPU configuration to execution of a second computing process using a second GPU configuration even when the second GPU configuration is different from the first GPU configuration.

As shown, step 202 depicts ongoing execution of a first computing process using a first GPU configuration. At some moment in time, it can happen that some event (e.g., event 111) would cause the first computing process to stop or to otherwise lose some functionality. When such a loss of functionality is detected (step 204), GPU reconfiguration technique 200 performs analysis of the first GPU configuration with respect to available GPU configurations. If an available GPU configuration is identified, then the “Yes” branch of decision 207 is taken and the process is reconfigured to use the second GPU configuration (step 208), after which reconfiguration of the process can be executed using the second GPU configuration (step 210).

In some cases during processing of step 206 to determine if the process can run using a particular alternative GPU configuration (e.g., a second GPU configuration, a third GPU configuration, etc.), it can happen that the processing of step 206 determines the process cannot run using a particular alternative GPU configuration. In such a case, a loopback commences (e.g., via the “No” branch of decision 207) after which step 212 serves to pick yet a different alternative GPU configuration. The loopback path re-enters at step 206, this time for consideration of the alternative GPU configuration.

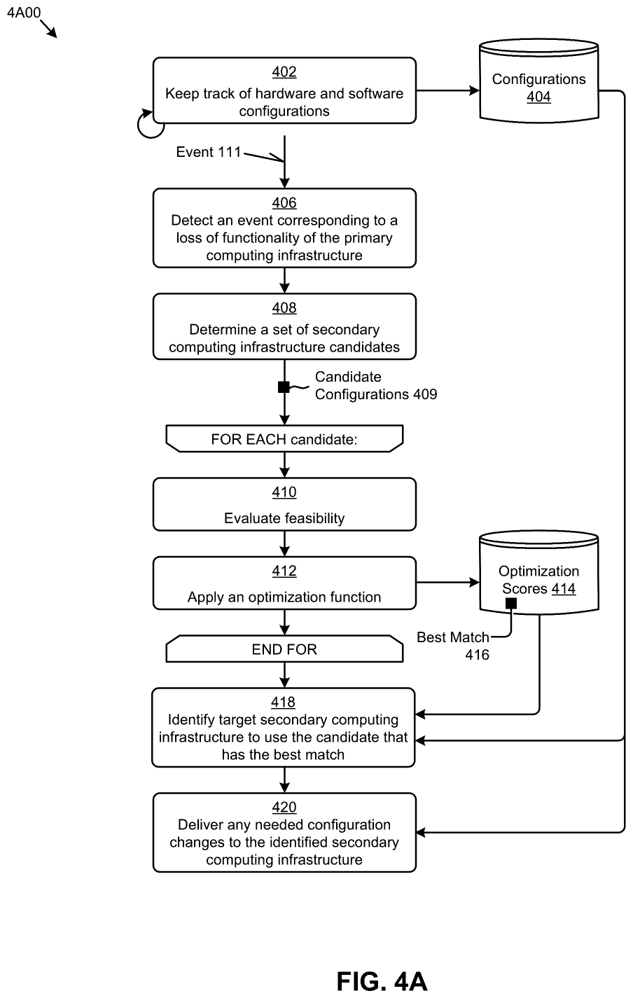

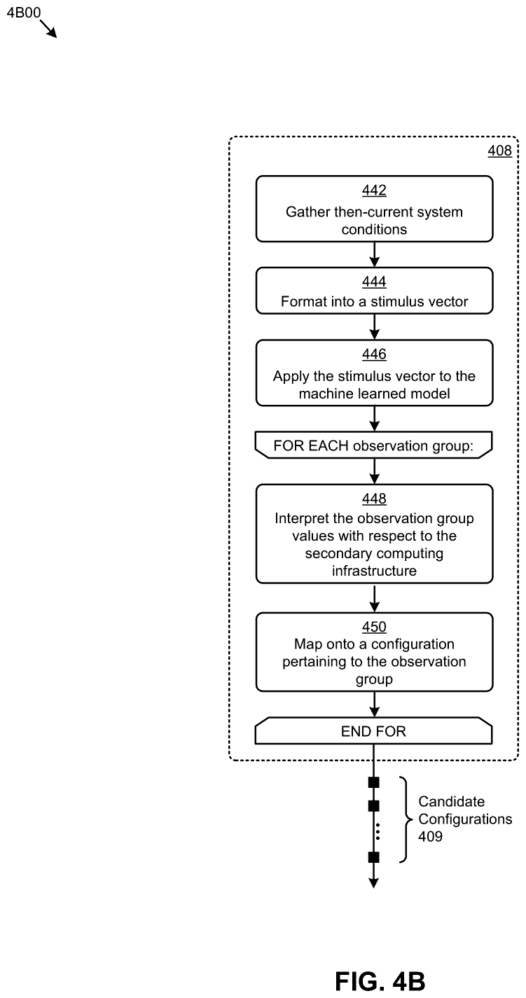

As can be seen by one of ordinary skill in the art, this GPU reconfiguration technique 200 can be applied in any computing architecture. Strictly as examples, GPU reconfiguration technique 200 can be applied, possibly repeatedly, in a high availability computing setting, possibly during recovery after a disaster. Additionally or alternatively, GPU reconfiguration technique 200 can be applied, possibly repeatedly, when migrating a process or group of processes from an on-premises setting to a cloud setting. Moreover, GPU reconfiguration technique 200 can be applied when new GPU hardware is introduced to a computing node. FIG. 3A1 and FIG. 3A2 depict several reconfiguration modes (e.g., up-provisioning and down-provisioning) that operate to dynamically reconfigure replacement GPUs.

FIG. 3A1 depicts a first set of GPU reconfiguration modes as used in systems that dynamically reconfigure replacement GPUs in accordance with corresponding demands for GPU resources. As an option, one or more variations of the first set of GPU reconfiguration modes 3A100 or any aspect thereof may be implemented in the context of the architecture and functionality of the embodiments described herein and/or in any environment.

The figure is being presented to illustrate the possibilities for reconfiguration when a target GPU profile is different from the source GPU profile. More specifically, the figure is being presented to illustrate (1) how certain GPU profiles project onto alternative GPU profiles in a manner that supports up-provisioning (case #1), (2) how certain GPU profiles project onto alternative GPU profiles in a manner that supports down-provisioning (case #2), and (3) how certain GPU profiles project onto alternative GPU profiles in a manner that prevents either up-provisioning or down-provisioning (case #3).

As used herein, a GPU profile is information that defines the metes and bounds of an amount and type of GPU hardware and/or its software driver. In exemplary cases, this information is codified into a data structure. In exemplary cases, this information is codified as a capability set.

To further explain, and specifically referring to case #1, consider that GPU profile T1 refers to features/capabilities of a GPU that form a proper subset of the features/capabilities of GPU profile T2. As such, when mapping a first GPU profile to a second GPU profile, all of the features/capabilities that might be demanded by a subject process that was using the first GPU can be provided by the second GPU, and then some (as shown). In some situations it is possible that the additional capabilities that the second GPU profile T2 provides in excess of the capabilities of the first GPU profile TI can be used to boost the GPU facilities' power provided to the subject process. In other situations, it is possible that the additional capabilities of the second GPU profile T2 can be provided to a different process.

As regards the shown case #2, it can happen that GPU profile T3 includes many, but not all of the features/capabilities of GPU profile T1. In this case, even though GPU profile T3 includes fewer than all of the features/capabilities of GPU profile T1, it might be possible to down-provision into GPU profile T3. Strictly as one example, suppose that GPU profile T1 includes 16 GB of GPU memory, but GPU profile T3 has only 8 GB of GPU memory. In accordance with this case #2, even though GPU profile T3 has only 8 Gb of memory, whereas GPU profile T1 has 16 GB of GPU memory, it might be possible to down-provision into GPU profile T3. In some cases, in spite of T3's GPU memory being only half the size of T1's GPU memory, it might have no effect on the overall system.

Consider two processes, each of which demands 8 GB of GPU memory. It could be that the two processes timeshare the GPU such that the first process uses 8 GB of GPU memory (e.g., for a graphical user interface (GUI) or other desktop application) and the second process also uses 8 GB of GPU memory (e.g., for a GUI or other desktop application). When the first process is in a pending state, its then current state of the GPU memory can be paged out, thus freeing up the 8 GB of GPU memory for the second process, and so on. The foregoing is a case where certain specific types of demanded GPU resources are fungible in the sense that GPU memory of the GPU device corresponding to GPU profile T1 is fungible with respect to a similar amount of GPU memory of the GPU device corresponding to GPU profile T3.

Most GPUs have a combination of fungible and non-fungible features/capabilities. For example, the feature/capability “ray tracing accelerator” cannot be treated as a fungible features/capability. In such cases, mapping may fail—at least for that combination of profiles. Case #3 illustrates such a case. As shown, there is a mismatch between GPU profile T1 and GPU profile T4 since GPU profile T1 specifies certain non-fungible features/capabilities that cannot be substituted or otherwise satisfied by GPU profile T4.

In most multi-node computing platforms it is at least theoretically possible that there might be many GPUs across the nodes. As such, even if one particular pair of GPU profiles does not match into an up-provisioning mode or into a down-provisioning mode, it might be possible that another pair of GPU profiles would satisfy the needs of an up-selection or down-selection. One way to improve the likelihood of finding match-compatible pairings is to select a secondary computing infrastructure (e.g., drawn from cloud vendor #1, or from cloud vendor #2, etc.) such that the secondary computing infrastructure does satisfy all of the demanded configurations. Determinations pertaining to whether or not a particular cloud-provided infrastructure can satisfy all of the demanded configurations can be facilitated by probing a cloud vendor's infrastructure for a manifest of available GPU configurations.

FIG. 3A2 depicts a second set of GPU reconfiguration modes as used in systems that dynamically reconfigure replacement GPUs in accordance with corresponding demands for GPU resources. As an option, one or more variations of the second set of GPU reconfiguration modes 3A200 or any aspect thereof may be implemented in the context of the architecture and functionality of the embodiments described herein and/or in any environment.

The figure is being presented to illustrate the possibilities for reconfiguration when a target set of GPU capabilities is different from a determined source set of GPU capabilities. More specifically, the figure is being presented to illustrate (1) how certain GPU capabilities project onto alternative GPU capabilities in a manner that supports up-provisioning (case #4), (2) how certain GPU capabilities project onto alternative GPU capabilities in a manner that supports down-provisioning (case #5), and (3) how certain GPU capabilities project onto alternative GPU capabilities in a manner that prevents either up-provisioning or down-provisioning (case #6).

As used herein, a GPU capability is information that defines the metes and bounds of an amount and type of GPU hardware and/or its software. In exemplary cases, this information is codified into a data structure.

To further explain, and specifically referring to case #4, consider that a GPU capability set T1 refers to features/capabilities of a GPU that forms a proper subset of the features/capabilities of GPU capability set T2. As such, when mapping a first GPU capability set to a second GPU capability set, all of the features/capabilities that might be demanded by a subject process that was using the first GPU can be provided by the second GPU, and then some (as shown). In some situations, it is possible that the additional capabilities that the GPU capability set T2 provides in excess of the capabilities of the GPU capability set T1 can be used to boost the GPU facilities' power provided to the subject process. In other situations, it is possible that the additional capabilities of the GPU capability set T2 can be provided to a different process.

As regards the shown case #5, it can happen that GPU capability set T3 includes many, but not all, of the features/capabilities of GPU capability set T1. In this case, even though GPU capability set T3 includes fewer than all of the features/capabilities of GPU capability set T1, it might be possible to down-provision into GPU capability set T3. Strictly as one example, suppose that GPU capability set T1 includes 16 GB of GPU memory, but GPU capability set T3 has only 8 GB of GPU memory. In accordance with this case #5, even though GPU capability set T3 has only 8 GB of memory, whereas GPU capability set T1 has 16 GB of GPU memory, it might be possible to down-provision into GPU capability set T3. In some cases, in spite of T3's GPU memory being only half the size of T1's GPU memory, it might have no effect on the overall system.

For example, consider two processes, each of which demands 8 GB of GPU memory. It could be that the two processes timeshare the GPU such that the first process uses 8 GB of GPU memory (e.g., for a graphical user interface (GUI) or other desktop application) and the second process also uses 8 GB of GPU memory (e.g., for a GUI or other desktop application). When the first process is in a pending state, its then current state of the GPU memory can be paged out, thus freeing up the 8 GB of GPU memory for the second process, and so on. The foregoing is a case where certain specific types of demanded GPU resources are fungible in the sense that GPU memory of the GPU device corresponding to GPU capability set T1 is fungible with respect to an amount of GPU memory of the GPU device corresponding to GPU capability set T3. In the foregoing fungibility case the amount of GPU memory is not identical, however a target-side GPU capability having, for instance, a greater amount of memory (e.g., 8 GB) can serve a demanded GPU capability of a lesser amount of memory (e.g., 4 GB). In contrast, however, a target-side GPU capability having, for instance, a lesser amount of memory (e.g., 2 GB) would not be considered as fungible such that the lesser amount of memory can serve a larger-demanded GPU capability (e.g., 4 GB).

Most GPU capability sets have a combination of fungible and non-fungible features/capabilities. For example, the feature/capability “ray tracing accelerator” might be vendor-specific and accordingly might not be treated as a fungible feature/capability (e.g., when different GPU vendors or different GPU models are involved). In such situations, mapping may fail-at least for that combination of capabilities. Case #6 illustrates such a situation. As shown, there is a mismatch between GPU capability set T1 and GPU capability set T4 since GPU capability set T1 specifies certain non-fungible features/capabilities that cannot be substituted or otherwise satisfied by GPU capability set T4.

In most multi-node computing platforms, it is at least theoretically possible that there might be many GPUs across the nodes. As such, even if one particular pair of GPU profiles does not map into an up-provisioning mode or into a down-provisioning mode, it might be possible that some pair of GPUs and their corresponding capability sets would satisfy the needs of an up-selection or down-selection. One way to improve the likelihood of finding match-compatible pairings is to select a secondary computing infrastructure (e.g., drawn from cloud vendor #1, or from cloud vendor #2, etc.) such that the secondary computing infrastructure can satisfy all of the demanded configurations. Determinations pertaining to whether or not a particular cloud-provided infrastructure can satisfy all of the demanded configurations can be facilitated by probing a cloud vendor's infrastructure for a manifest of available GPU configurations.

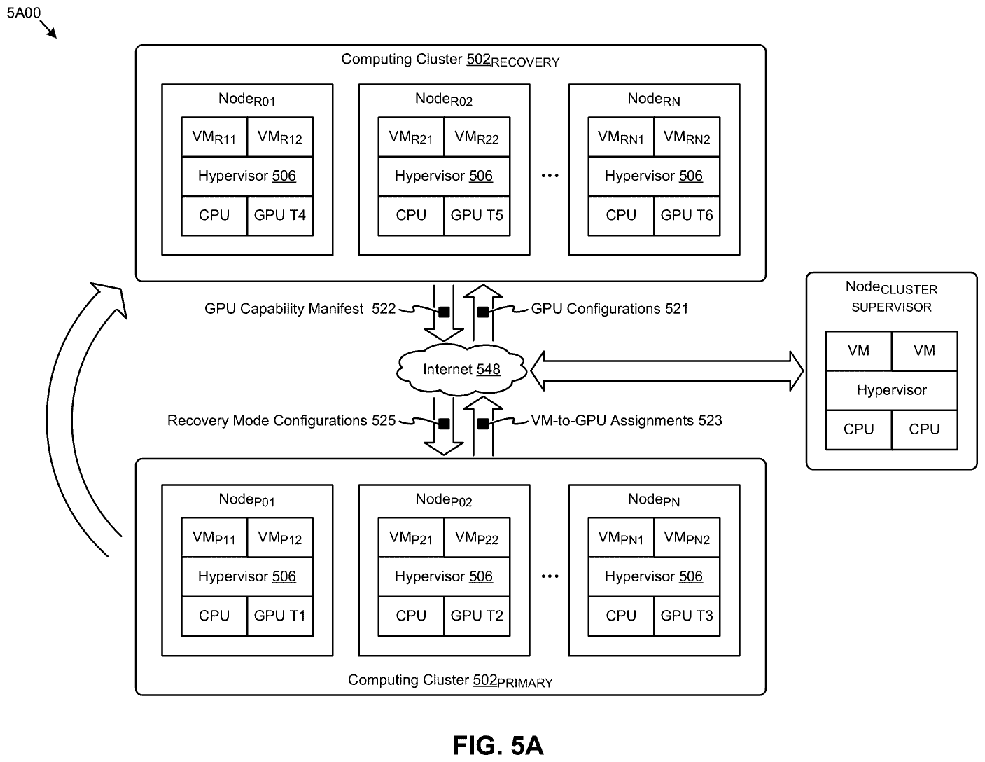

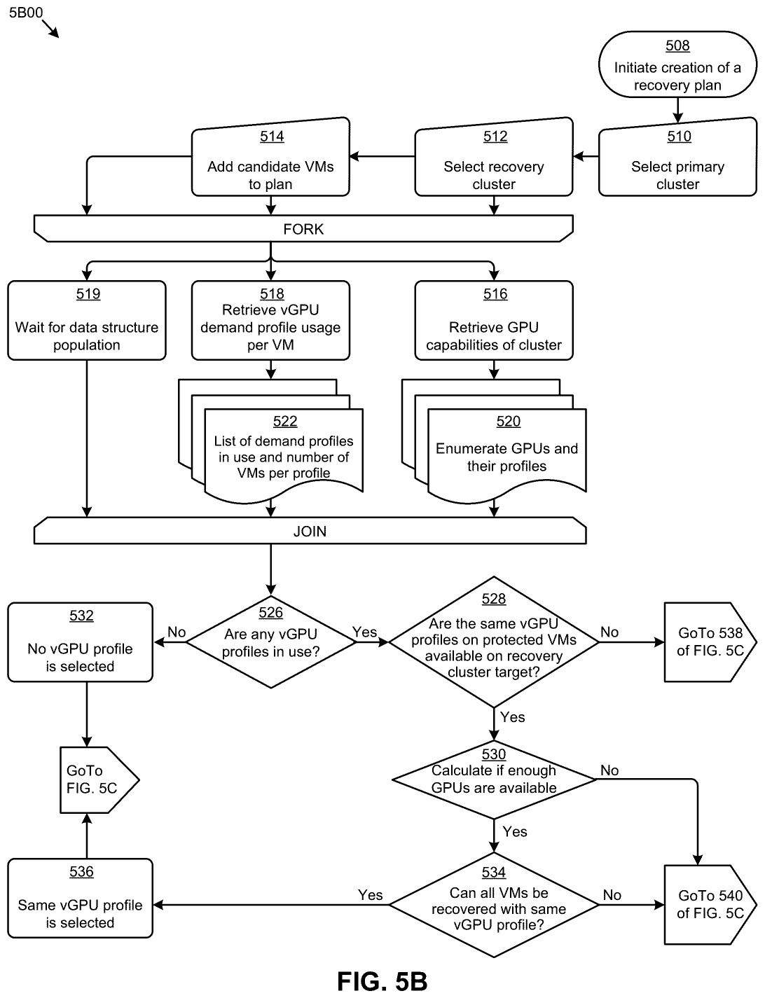

One approach to identifying a secondary computing infrastructure that does satisfy all of the demanded configurations is shown and described as pertains to FIG. 4A and FIG. 4B.

FIG. 4A depicts a first secondary computing infrastructure selection technique as used in systems that dynamically reconfigure replacement GPUs in accordance with computing process demands for GPU resources. As an option, one or more variations of the first secondary computing infrastructure selection technique 4A00 or any aspect thereof may be implemented in the context of the architecture and functionality of the embodiments described herein and/or in any environment.

The figure is being presented to illustrate one way to identify a secondary computing infrastructure that satisfies all of the demanded configurations. Moreover, the figure is being presented to illustrate one way to optimize selection of a secondary computing infrastructure that satisfies all of the demanded configurations.

The figure depicts an ongoing task 402 that keeps track of hardware and software configurations 404 of the primary computing infrastructure as well as any one or more candidate target computing infrastructures. In some cases, the changes to the configurations of any computing infrastructure are under control by the same entity. In other cases, the configurations of a potential target computing infrastructure might be under control by an entity that is different from the entity that operates the source computing infrastructure. In still other cases, such as when cloud-based infrastructure is used, the configuration of a candidate target computing infrastructure can be deferred until after event 111 and a corresponding loss of functionality has been detected.

The occurrence of event 111 and any detection of a corresponding loss of functionality of the primary computing infrastructure (step 406) leads to a series of steps that analyze multiple secondary computing infrastructure candidates so as to resolve to an intended target computing system that is a suitable (or possibly optimal) replacement for the source computing system that suffered the loss of functionality. Specifically, step 408 serves to identify one or more secondary computing infrastructure candidates (e.g., the shown candidate configurations 409) such that those candidates can be analyzed for feasibility (step 410) and for optimality (step 412). An optimization score (e.g., results of an optimization functions) for each candidate secondary computing infrastructure is stored in one or more persistent storage locations that are suitable for maintaining a plurality of optimization scores 414.

When all multiple secondary computing infrastructure candidates have been considered, the best match 416 (or multiple best matches in case of a tie) are considered with respect to the last known configuration of the (now lost) primary computing infrastructure as compared with the configuration of the best match target computing infrastructure (step 418). In some cases, it can happen that the best match target computing infrastructure is not precisely in the configuration as demanded by any software components of the (now lost) primary computing infrastructure. For example, a plurality of software components might each demand 2 GB of frame buffer. To accommodate this, the target computing infrastructure, specifically a GPU of the target computing infrastructure, might be configured with multiple 2 GB private memory partitions, which in aggregate satisfies the plurality of software components under consideration. This is merely one example, and other configuration changes are possible. Accordingly, step 420 serves to deliver any needed configuration changes to the identified secondary computing infrastructure.

As shown, step 408 serves to identify a set of secondary computing infrastructure candidates. The identification can use any known technique, possibly involving heuristics, rules, profile comparisons, etc. However, in some embodiments machine learning and/or other artificial intelligence techniques can be deployed so as to augment or supplant the techniques that underly the processing of step 408. One possible implementation of step 408 is shown and described as pertains to FIG. 4B.

FIG. 4B depicts selected operations pertaining to a second secondary computing infrastructure selection technique 4B00 as used in systems that dynamically reconfigure replacement GPUs in accordance with computing process demands for GPU resources. As an option, one or more variations of second secondary computing infrastructure selection technique 4B00 or any aspect thereof may be implemented in the context of the architecture and functionality of the embodiments described herein and/or in any environment.

The figure is being presented to illustrate an additional or alternative way to identify a secondary computing infrastructure that satisfies all or parts of the demands. As depicted, the secondary computing infrastructure selection technique 4B00 includes an implementation of step 408 of FIG. 4A, which step serves to identify one or more secondary computing infrastructure candidates (e.g., the shown candidate configurations 409). This embodiment carries out a set of method steps, an initial step of which commences by gathering observed information such as then-current system conditions (step 442). Some of the observed information can be assigned into one or more observation groups. Similarly, some of the observed information can be formatted into a stimulus vector (step 444).

The foregoing can be carried out at any moment in time, even continuously and in parallel with other operations. Once a stimulus vector has been formatted for the machine learned model and associated with any/all bits of other portions of the gathered information (e.g., observation groups), any given stimulus vector can be applied to the machine learned model (step 446). In due course, a stimulus vector is applied to the machine learned model, and observation groups are emitted. Step 448 serves to interpret any/all of the observation group values with respect to a secondary computing infrastructure, after which interpretation the selection technique maps aspects of the observation group onto various infrastructure that can serve as secondary computing infrastructure (step 450). The secondary computing infrastructure selection technique 4B00 need not actually configure the secondary computing infrastructure, but rather the secondary computing infrastructure selection technique might merely emit candidate configurations 409, which are in turn used in downstream operations (e.g., as might occur in target cluster configuration or reconfiguration scenarios).

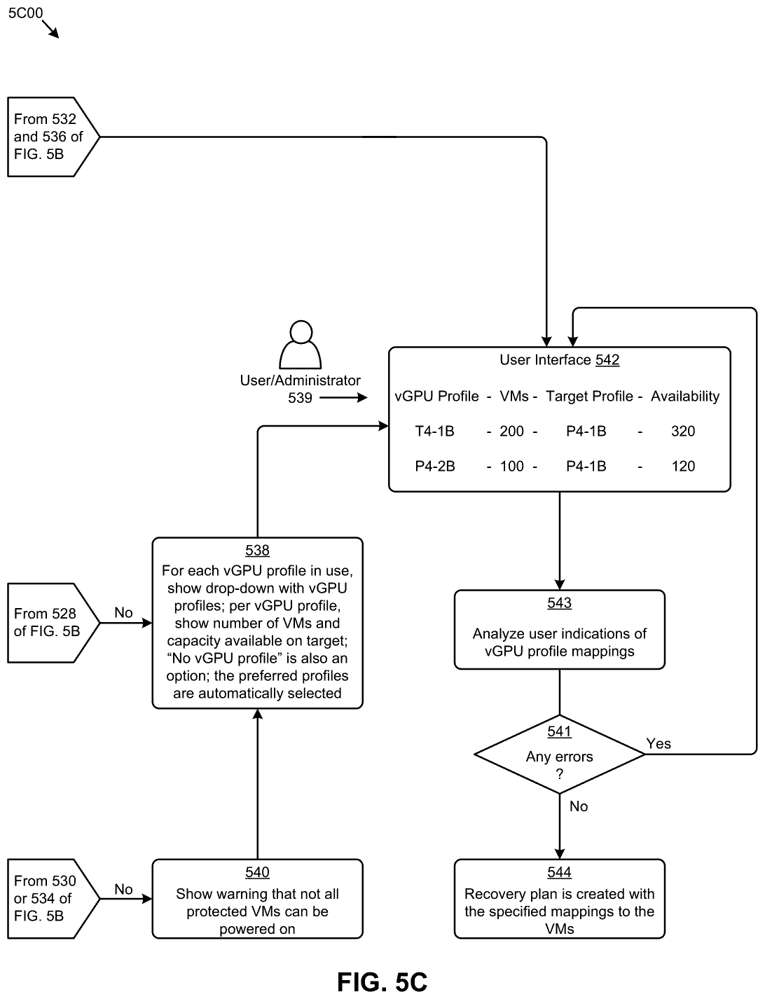

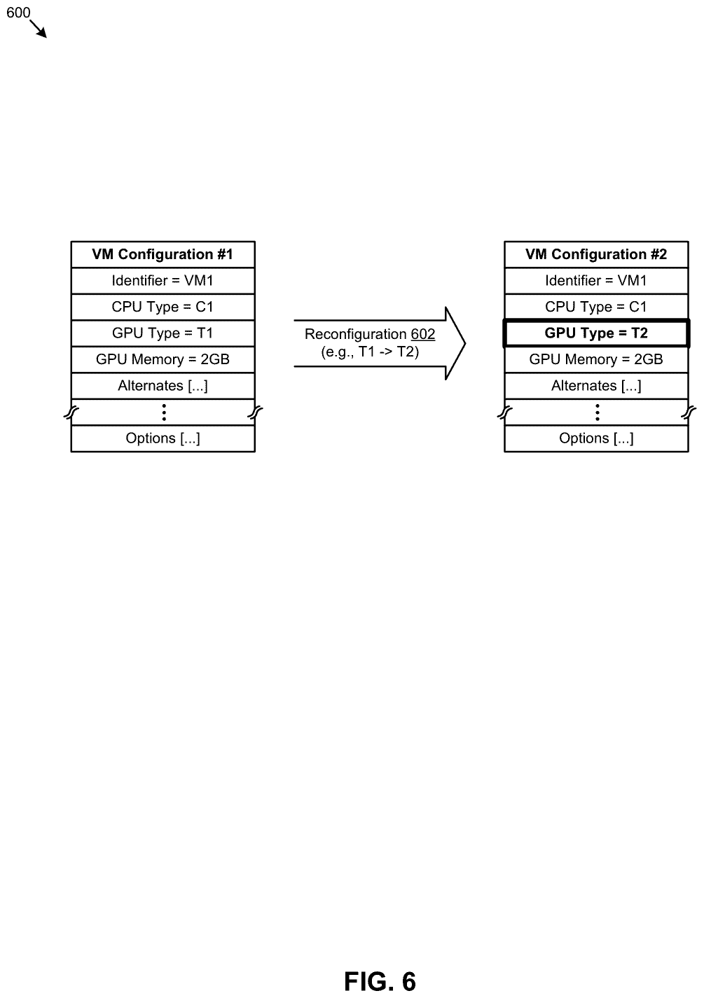

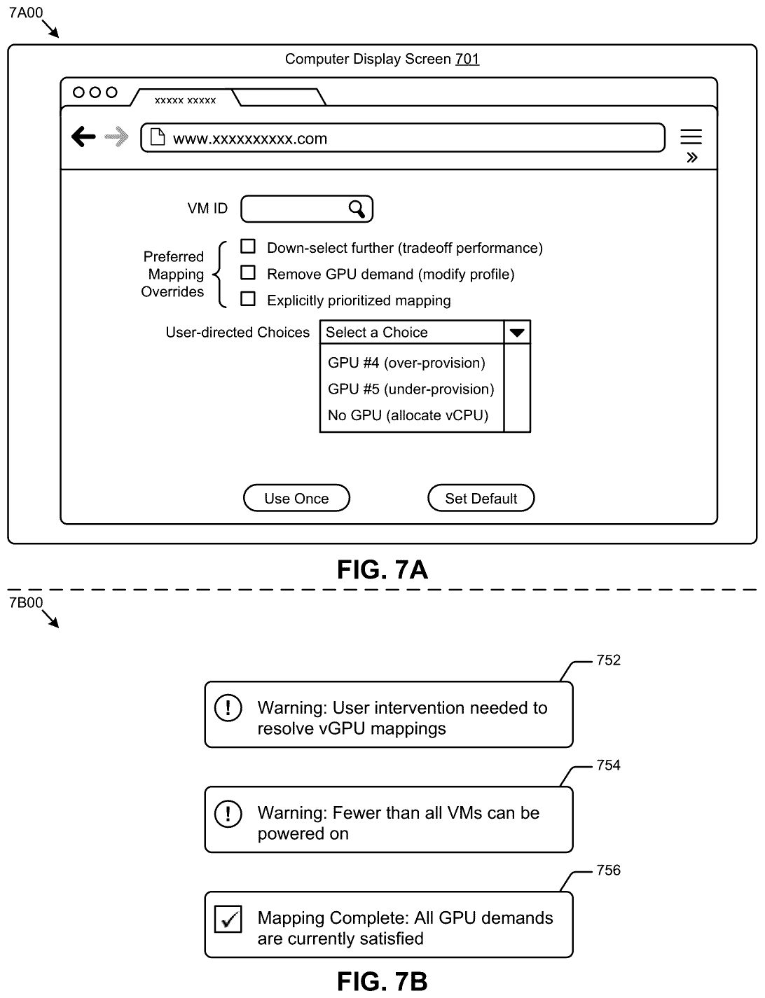

FIG. 5A depicts a target cluster reconfiguration scenario as used in systems that dynamically reconfigure replacement GPUs in accordance with corresponding demands for GPU resources. As an option, one or more variations of target cluster reconfiguration scenario 5A00 or any aspect thereof may be implemented in the context of the architecture and functionality of the embodiments described herein and/or in any environment.

The figure is being presented to illustrate an environment in which a recovery computing cluster (e.g., recovery computing cluster 502_{RECOVERY}) can be maintained in a standby mode such that, in event of a loss of functionality of primary computing cluster 502_{PRIMARY}, the recovery computing cluster can be brought up with substantially the same operational capabilities as was available on the (now failed) primary computing cluster.

As shown, each computing cluster includes a plurality of interconnected computing nodes (e.g., node_{PO1}, node_{PO2}, . . . , node_{PN}; node_{R01}, node_{R02}, . . . , node_{RN}), with each node having at least one CPU, at least some components of a virtualization system (e.g., hypervisor 506), and any number of virtual machines (e.g., VM_{R11}, VM_{R12}, VM_{R21}, VM_{R22}, VM_{RN1}, VM_{RN2}, VM_{P11}, VM_{P12}, VM_{P21}, VM_{P22}, VM_{PN1}, VM_{PN2}). In this particular embodiment, the nodes of each computing cluster each also includes graphics processing units of different types (e.g., GPU T1, GPU T2, GPU T3, GPU T4, GPU T5, GPU T6). The computing clusters communicate over Internet 548. Further, each of the two shown computing clusters can be monitored and configured by the independent node labeled as node_{CLUSTERSUPERVISOR}. More particularly, the independent node labeled as node_{CLUSTERSUPERVISOR} is able to load virtual machines onto the computing clusters, and thereafter, start/restart those virtual machines.

During ongoing operation, primary computing cluster 502_{PRIMARY}, is able to retrieve a GPU capability manifest 522 as well as recovery mode configurations 525 from recovery computing cluster 502_{RECOVERY}. This permits primary computing cluster 502_{PRIMARY} to pre-stage the shown recovery computing cluster 502_{RECOVERY} such that in event of a failure or loss of functionality of primary computing cluster 502_{PRIMARY}, then recovery computing cluster 502_{RECOVERY} can be quickly brought up as a replacement. More particularly, and with respect to the herein-disclosed techniques, the primary computing cluster 502_{PRIMARY} can pre-stage the shown recovery computing cluster 502_{RECOVERY} with specific GPU configurations 521. In some cases, primary computing cluster 502_{PRIMARY} can pre-stage the shown recovery computing cluster 502_{RECOVERY} with specific VM-to-GPU assignments 523.

Determination and mapping of the specific GPU configurations 521 can be automated by a computing element running in the independent node labeled as node_{CLUSTERSUPERVISOR}. In some cases, determination and mapping of certain of the specific GPU configurations 521 can be facilitated by a user or administrator who manipulates graphical screen widgets of a user interface.

A user or administrator might want to create a GPU resource recovery plan in advance of any failure event. FIG. 5B shows an example process for creating the GPU resource recovery plan. FIG. 5C shows an example of how a user or administrator might interact with a graphical user interface to define specific characteristics of such a GPU resource recovery plan.

Once a GPU resource recovery plan has been codified then, responsive to occurrence of a failure event, the GPU resource recovery plan or variation thereof can be invoked by an administrator. When such a GPU resource recovery plan is invoked, various checks are carried out to validate that the pre-defined GPU resource recovery plan is still feasible. More specifically, checks are carried out to validate that the GPU profiles used in the GPU resource recovery plan are indeed available at the recovery location. If so, then the GPU resource demands of the processes of the source computing infrastructure can be satisfied by the GPUs of the recovery computing infrastructure.

FIG. 5B depicts a process for creating the GPU resource recovery plan as used to dynamically reconfigure replacement GPUs in accordance with corresponding demands for GPU resources. As an option, one or more variations of virtualization system planning system 5B00 or any aspect thereof may be implemented in the context of the architecture and functionality of the embodiments described herein and/or in any environment.

The shown process for creating the GPU resource recovery plan commences at step 508 that initiates creation of a GPU resource recovery plan. The plan generation can be applied to any pair of clusters. Accordingly a first cluster (e.g., the primary cluster of step 510) is selected, followed by a selection of a recovery cluster (process 512). Step 514 serves to load all candidate VMs into the plan. In some cases candidate VMs include all VMs that were running at the time of the failure. In some cases the candidate VMs exclude VMs that are not intended to be restarted.

Several procedures are invoked within a FORK/JOIN block. As shown, process 518 serves to retrieve virtual GPU (vGPU) demand profiles for each VM. Process 518 executes in parallel with process 519 and process 516. Within this FORK/JOIN block, process 516 serves to retrieve GPU capabilities from the selected recovery cluster. Concurrently, GPU demand profiles for the VMs are retrieved (process 518). The GPU demand profiles are stored in a first data structure 522, whereas all GPU profiles corresponding to the GPUs of the recovery cluster are stored in second data structure 520. When the foregoing data structures have been populated, the planning system of FIG. 5B continues.

Such planning involves assessment of demanded GPU capabilities with respect to GPU availabilities. In some cases, there are no demands for GPU capabilities, in which case the “No” branch of decision 526 is taken and the determination that there are no GPU demands is codified (step 532). On the other hand, it might happen that, indeed, there are demands for GPU capabilities, in which case, the “Yes” branch of decision 526 is taken and a determination is made (decision 528) as to whether the GPU demand profiles match up with the available GPU profiles of the recovery cluster. Then decision 530 calculates of there exists sufficient GPU availability at the target-side infrastructure to satisfy all demand profiles. If so, then flow proceeds to decision 534 where it is determined whether or not all VMs can be recovered using the same vGPU demand profile. If so, then the “Yes” branch of decision 534 is taken and the same vGPU demand profile is selected (action 536).

As used herein, a GPU demand profile (or vGPU demand profile) is information that defines the metes and bounds of an amount and type of GPU support requested by a computing process. In exemplary cases, this information is codified into a computer data structure. In exemplary cases, human-readable characteristics of GPU demands and/or an amalgamation of demands across multiple GPU demand profiles data structures can be presented in a graphical user interface (GUI). Certain mapping situations can be confirmed, augmented, or remediated using such a GUI.

All of the steps of the FIG. 5B process for creating the GPU resource recovery plan can be carried out automatically. However, it can sometimes happen that a user or administrator can modify (e.g., override or otherwise adjust) the automatically determined mappings. To provide for such a possibility of user or administrative modifications of the automatically determined mappings, some embodiments include a user interface to facilitate such user or administrative modifications.

To illustrate mapping situations when GPU mapping is fully automatic versus when GPU mapping is partially automatic and partially subject to user intervention, consider the following four scenarios:

Scenario #1 addresses the case when no vGPU profiles are in use. In this scenario, no GPU mapping is needed.

Scenario #2 addresses the case when the same vGPU profiles that are in use in the failed computing infrastructure (e.g., source computing infrastructure) are also available in the recovery computing infrastructure (e.g., target computing infrastructure). The same vGPU profiles that were in use by the VMs of the failed computing infrastructure are selected for use by the VMs of the recovery computing infrastructure.

Scenario #3 addresses the case where the same profiles are available, but according to the aggregate GPU demand level, there are not enough GPU resources at the recovery computing infrastructure to satisfy all demands.

Scenario #4 addresses the case when at least some profiles available on the recovery computing infrastructure are different as compared to the profiles that were in use at the failed computing infrastructure.

For scenario #3 and scenario #4 there are various alternative options. For instance, Option #1 involves fully automatic configuration of vGPU profiles. In some cases such automatic configuration of vGPU profiles are automatically configured according to any one or more default mapping overrides. Option #2 involves semi-automatic configuration. Under this option, a set of vGPU profiles are automatically configured/reconfigured, however a GUI is presented such that a user or administrator can see an overview of the mappings and can then make adjustments using widgets of the GUI. Option #3 involves manual configuration. For manual configuration, a user or administrator is presented with a GUI. The GUI has sufficient widgets to facilitate user- or administrator-defined mappings from various source vGPU profiles to target vGPU profiles. Both up-provisioning and down-provisioning are supported. A use model for using a GUI is shown and described as pertains to FIG. 5C.

FIG. 5C depicts a user interface use model as used in combination with user-influenced selection of replacement graphics processing units (GPUs). As an option, one or more variations of user interface use model 5C00 or any aspect thereof may be implemented in the context of the architecture and functionality of the embodiments described herein and/or in any environment.

The figure is being presented to explain how a user or administrator can interact with a GUI in the event that user-assisted or administrative-assisted mappings are desired. Specifically, it can happen that the “No” branch of decision 534 is taken because there needs to be multiple different vGPU demand profiles involved when mapping to a recovery cluster. In such a case, the user interface indicates (at step 540) that user intervention might be required to complete the mapping. In another scenario, it can happen that the “No” branch of decision 528 is taken because there needs to be multiple different vGPU demand profiles involved when mapping to a recovery cluster. In such a case, the user interface is populated (step 538) with sufficient information such that the user can supply additional information as may be needed to complete the mapping. In this embodiment, a screen widget 542 is presented to a user or administrator. The screen widget facilitates user selection or overrides of GPU profiles to be associated with various VMs. It should be noted that the screen widget 542 is configured such that the GPU demands of many VMs can be mapped in batches.

When the user/administrator 539 has finished interaction with screen widget 542, the flow proceeds to step 543 where the user indications are analyzed. If there are no errors in the mappings (test 541), the “No” branch is taken and the recovery plan is codified in accordance with the specified vGPU demand profiles (step 544). Otherwise, the “Yes” branch taken and the user/administrator can remediate the errors using screen widget 542. When the recovery plan is executed, the computing processes that were formerly executing on the failed cluster are restarted on the target cluster. Any VMs that are candidates for restarting and/or any metadata pertaining to any VMs that are candidates for restarting might be modified to be restarted with one of the up-provisioned or down-provisioned GPU demand profiles.

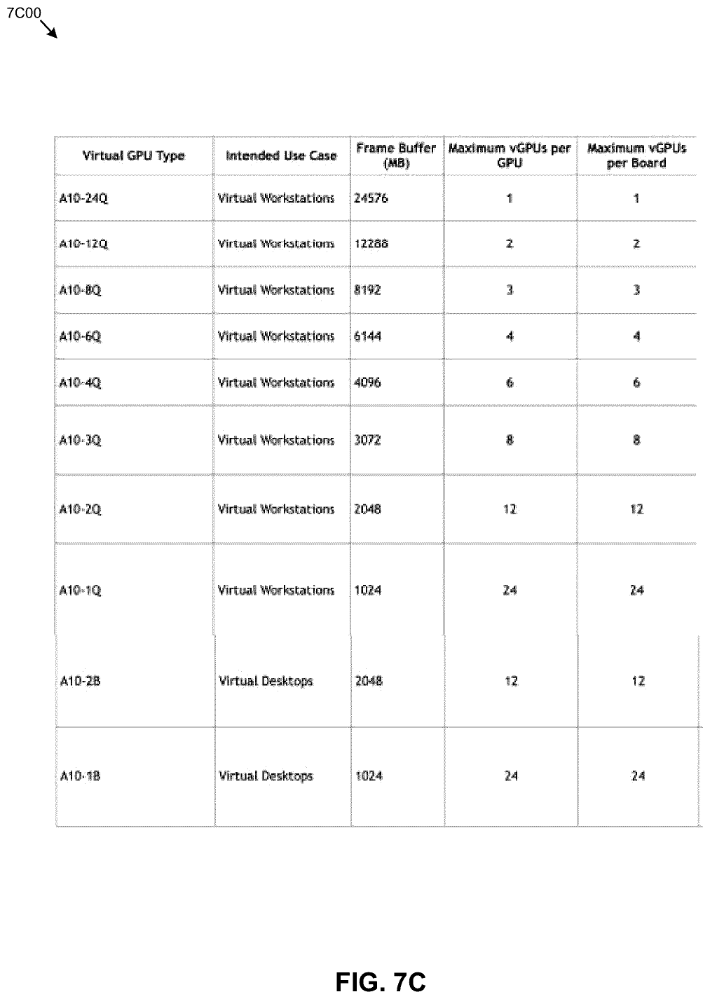

As can now be understood, the demand profiles of any one or more VMs can be modified such that the demand can be satisfied by one or more of the GPUs of the recovery cluster. As previously indicated, it is possible that the mapping results in a down-provisioning, where the mapping results in fewer GPU capabilities being given to the virtual machine. Also, it is possible that the mapping results in an up-provisioning, where the mapping results in more GPU capabilities being given to the virtual machine. To further explain, FIG. 6 shows and describes up-provisioning, where a VM is reconfigured to use a more powerful type of GPU of the recovery cluster.

There are many variations to the flow of FIG. 5C. More particularly, there are many alternative embodiments of screen widget 542. In the shown embodiment, for each vGPU profile demanded, a number of VMs that demand a particular vGPU profile are presented. Also, for each such vGPU profile, there is a dropdown/selection box that contains the available vGPU profiles from the target cluster. In some embodiments, one or more screen widgets can show the number of available VMs that could be hosted under that profile. As can be understood by those of ordinary skill in the art, the target profiles listed and corresponding availabilities are dynamic items. That is, when a target profile is assigned, that choice might impact the choices available for the next type of profile. Additionally or alternatively, instead of displaying a listing that is organized on a per source vGPU profile basis, it is possible to present a listing that is organized by source VMs in which their corresponding source vGPU profiles are presented next to each listed VM. A selection box or other widget presents possible target vGPU profiles.

As can be seen, it is possible that a virtual machine that had been configured for a (for example) GPU demand corresponding to a lower capability GPU can be reconfigured to a GPU demand corresponding to a higher capability GPU. Strictly as one example, a virtual machine GPU profile reconfiguration scenario is shown and described as pertains to FIG. 6.

FIG. 6 depicts a virtual machine GPU profile reconfiguration scenario as used in virtualization systems that dynamically reconfigure replacement GPUs in accordance with corresponding GPU demands from a virtual machine. As an option, one or more variations of virtual machine GPU profile reconfiguration scenario 600 or any aspect thereof may be implemented in the context of the architecture and functionality of the embodiments described herein and/or in any environment.

The figure depicts two VM configurations, “VM Configuration #1” and “VM Configuration #2.” Each configuration includes a VM identifier (e.g., “VM1”), a CPU type (e.g., “C1”), a GPU memory minimum constraint (e.g., “2 GB”), and other alternates and options. Further, each configuration includes a GPU type (e.g., “T1”, “T2”). In the shown example, the acts of reconfiguration 602 serves to up-provision from a GPU of type=“T1” to a GPU of type=“T2”.

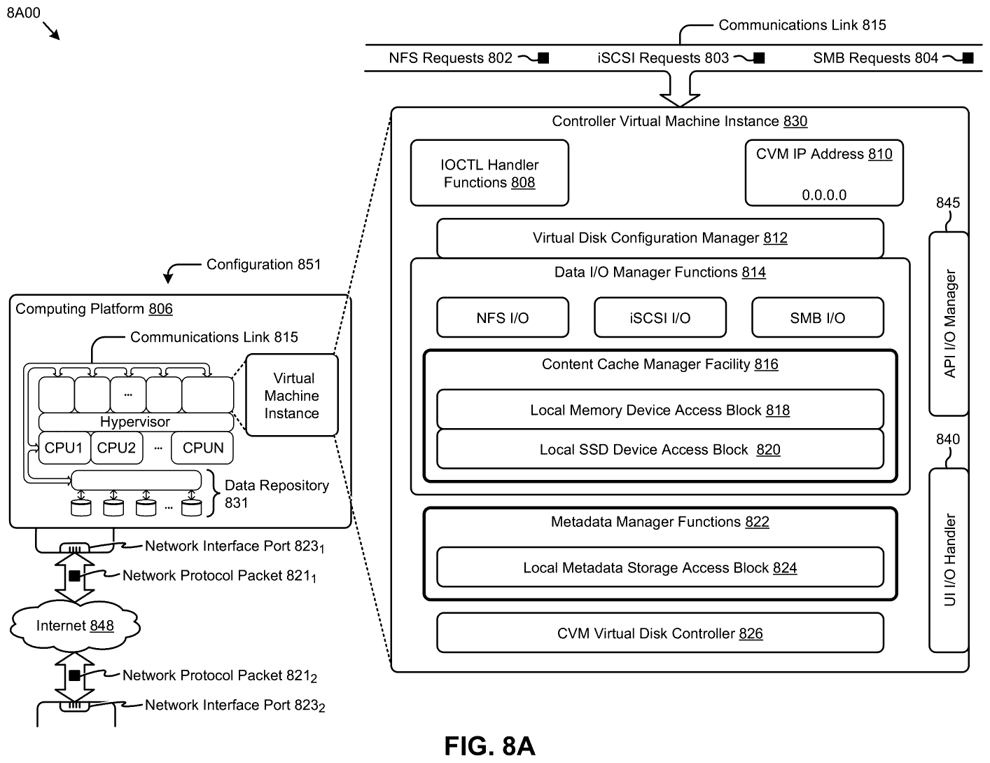

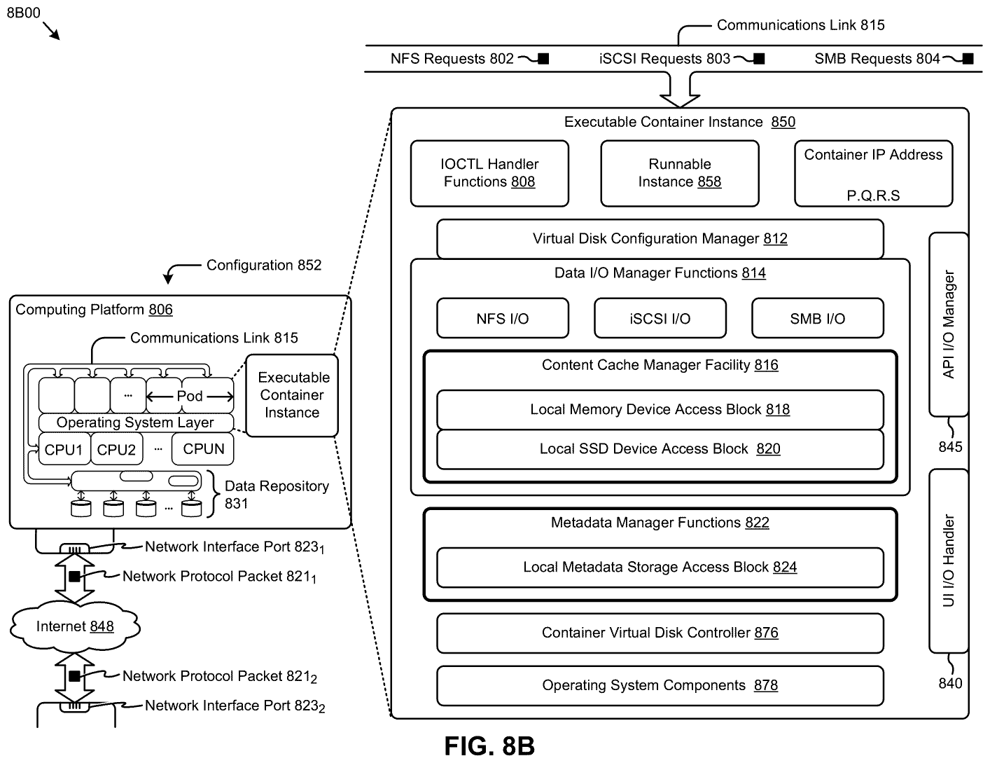

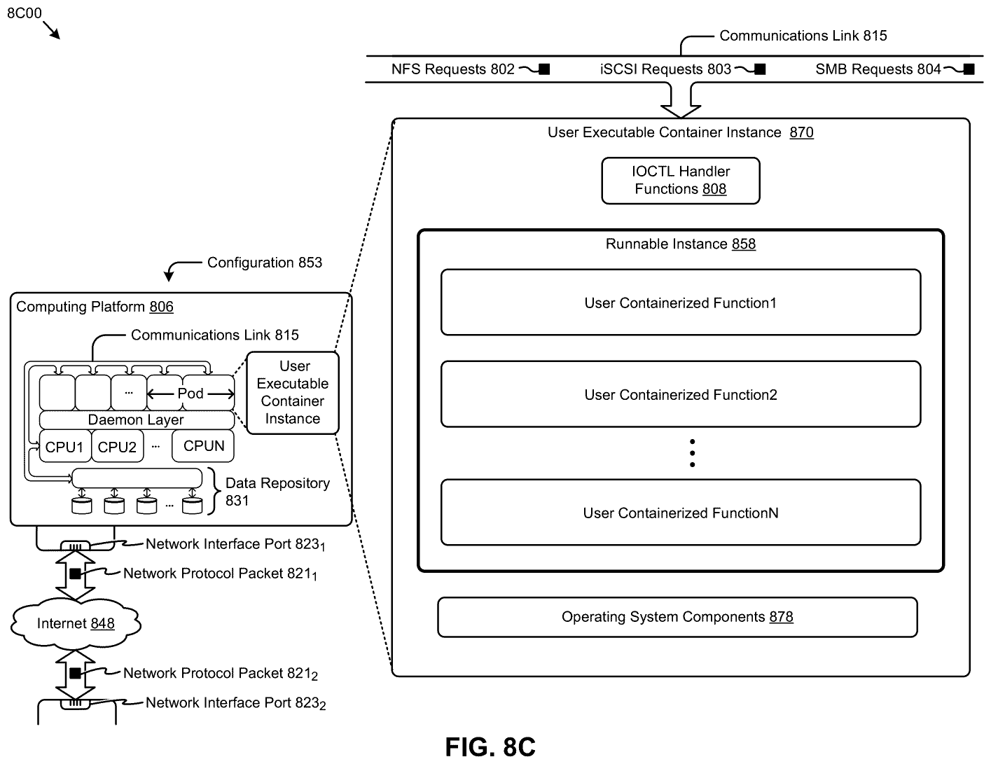

FIG. 7A depicts a sample GPU reconfiguration user interface as used in systems that provide user-defined reconfigurations of GPUs. As an option, one or more variations of GPU reconfiguration user interface 7A00 or any aspect thereof may be implemented in the context of the architecture and functionality of the embodiments described herein and/or in any environment.

As shown, the GPU reconfiguration user interface is presented in a computer display screen 701. The GPU reconfiguration user interface includes an input box for designation of a virtual machine ID. The virtual machine ID can be automatically populated. Additionally or alternatively, it can be entered or overridden by a user/administrator.

A selection of preferred mapping overrides are shown, any one or more of which can be enabled/disabled by a user or administrator (e.g., via a checkbox widget). The GUI includes a further selection widget that permits the user/administrator to indicate preferences for mapping the identified VM to a particular GPU. As shown, both over-provisioning and under-provisioning options are presented as possible user-directed choices.

It should be noted that although it might be possible to configure upwards to a more capable GPU (up-provisioning, based on upward compatibility), and although it might be possible to configure downwards to a less capable GPU (down-provisioning, based on downward compatibility), it might not always be possible to find a suitable second GPU reconfiguration. This can happen if there are demands for GPU capacity or functionality in the first GPU configuration that cannot be satisfied by any considered second GPU configurations. Accordingly, the user interface presents choices that include mapping of the GPU demands of the identified VM onto a virtual CPU by down-selecting to a software implementation of graphics handling features).

In any of the foregoing mapping operations (e.g., up-provisioning or down-provisioning), characteristics of the identified VM are modified to reflect the result(s) of the mapping operations. The modified VM is then subjected to being restarted on the target node.

It should be noted that during user/administrator interaction with the GPU reconfiguration user interface, it can happen that the state of the mapping changes. Accordingly, various GPU mapping status indicators are provided, a selection of which GPU mapping status indicators are shown and described as pertains to FIG. 7B.

FIG. 7B depicts sample GPU mapping status indicators as used in systems that provide user-influenced reconfigurations of GPUs. As an option, one or more variations of GPU mapping status indicators 7B00 or any aspect thereof may be implemented in the context of the architecture and functionality of the embodiments described herein and/or in any environment.

While the processing depicted in FIG. 5B and FIG. 5C is being carried out, whether by operation of the foregoing automation or by operation of a user or admin over a user interface, various indications might be presented to the user in graphical format. Strictly as an example, a warning 752 might be displayed, possibly on multiple screens, in the event that user intervention is needed to resolve mappings. As another example, a more severe warning 754 might be displayed, possibly on multiple screens, in the event that fewer than all of the VMs can be powered on (e.g., because at least one VM cannot be mapped to available GPU resources of the recovery cluster). As yet another example, a success indication 756 might be displayed, possibly on multiple screens, in the event that all GPU demands of all VMs that are to be restarted on the recovery cluster can be satisfied by the available GPU resources of the recovery cluster.

FIG. 7C depicts sample virtual GPU profile options 7C00 as used in systems that provide user-defined reconfigurations of GPUs, according to an embodiment.

There are many possible configurations of a GPU. The shown configurations are merely illustrative. Other configurations involving GPU capabilities in other dimensions are possible. Certain GPU capabilities are provided by the hardware of a GPU, while certain GPU capabilities are provided by a software driver or firmware for or of a particular GPU or type of GPU. As shown, a particular hardware GPU can serve as a host device for many virtual GPUs. In some cases, a particular hardware GPU can support a plurality (e.g., 2, 4, 12, 24, etc.) of the same virtual GPUs (e.g., in accordance with a homogeneous deployment setting). In other cases, a particular hardware GPU can support a plurality of differently configured virtual GPUs (e.g., in accordance with a heterogeneous deployment setting).

It should be noted that the software components discussed herein might be any one of (1) an operating system component, (2) a process that runs under an operating system, (3) a virtualization system hypervisor component, (4) a virtualization system controller virtual machine, (5) a user virtual machine, (6) an executable container, or (7) any other partitioning or embodiment of an executable software component. Further it should be noted that any/all of the foregoing types of partitions or embodiments of an executable software component can be combined to form a computing cluster. In some multi-cluster environments, a target computing cluster can be designated as a secondary platform in case of a failure of the primary platform. Moreover, in some such multi-cluster environments, a standalone multi-cluster supervisor node can facilitate how to bring-up a target recovery platform in case of a failure of the primary platform.

### System Architecture Overview

### Additional System Architecture Examples

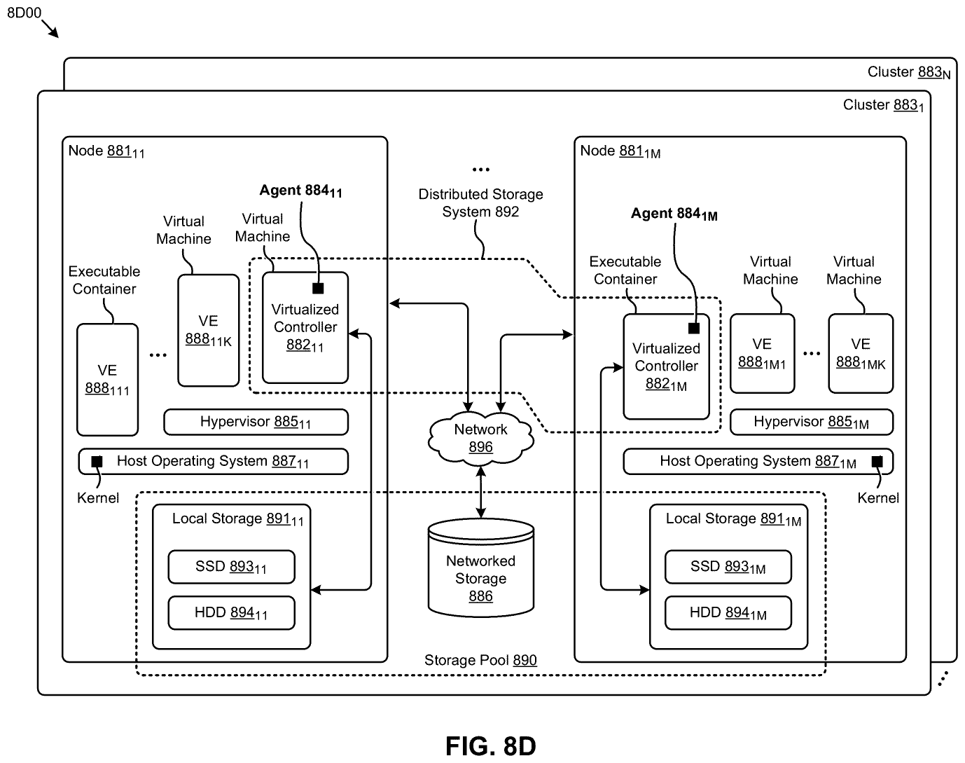

All or portions of any of the foregoing techniques can be partitioned into one or more modules and instanced within, or as, or in conjunction with, a virtualized controller in a virtual computing environment. Some example instances of virtualized controllers situated within various virtual computing environments are shown and discussed as pertains to FIG. 8A, FIG. 8B, FIG. 8C, and FIG. 8D.

FIG. 8A depicts a virtualized controller as implemented in the shown virtual machine architecture 8A00. The heretofore-disclosed embodiments, including variations of any virtualized controllers, can be implemented in distributed systems where a plurality of networked-connected devices communicate and coordinate actions using inter-component messaging.

As used in these embodiments, a virtualized controller is a collection of software instructions that serve to abstract details of underlying hardware or software components from one or more higher-level processing entities. A virtualized controller can be implemented as a virtual machine, as an executable container, or within a layer (e.g., such as a layer in a hypervisor). Furthermore, as used in these embodiments, distributed systems are collections of interconnected components that are designed for, or dedicated to, storage operations as well as being designed for, or dedicated to, computing and/or networking operations.

Interconnected components in a distributed system can operate cooperatively to achieve a particular objective such as to provide high-performance computing, high-performance networking capabilities, and/or high-performance storage and/or high-capacity storage capabilities. For example, a first set of components of a distributed computing system can coordinate to efficiently use a set of computational or compute resources, while a second set of components of the same distributed computing system can coordinate to efficiently use the same or a different set of data storage facilities.

A hyperconverged system coordinates the efficient use of compute and storage resources by and between the components of the distributed system. Adding a hyperconverged unit to a hyperconverged system expands the system in multiple dimensions. As an example, adding a hyperconverged unit to a hyperconverged system can expand the system in the dimension of storage capacity while concurrently expanding the system in the dimension of computing capacity and also in the dimension of networking bandwidth. Components of any of the foregoing distributed systems can comprise physically and/or logically distributed autonomous entities.

Physical and/or logical collections of such autonomous entities can sometimes be referred to as nodes. In some hyperconverged systems, compute and storage resources can be integrated into a unit of a node. Multiple nodes can be interrelated into an array of nodes, which nodes can be grouped into physical groupings (e.g., arrays) and/or into logical groupings or topologies of nodes (e.g., spoke-and-wheel topologies, rings, etc.). Some hyperconverged systems implement certain aspects of virtualization. For example, in a hypervisor-assisted virtualization environment, certain of the autonomous entities of a distributed system can be implemented as virtual machines. As another example, in some virtualization environments, autonomous entities of a distributed system can be implemented as executable containers. In some systems and/or environments, hypervisor-assisted virtualization techniques and operating system virtualization techniques are combined.

As shown, virtual machine architecture 8A00 comprises a collection of interconnected components suitable for implementing embodiments of the present disclosure and/or for use in the herein-described environments. Moreover, virtual machine architecture 8A00 includes a virtual machine instance in configuration 851 that is further described as pertaining to controller virtual machine instance 830. Configuration 851 supports virtual machine instances that are deployed as user virtual machines, or controller virtual machines or both. Such virtual machines interface with a hypervisor (as shown). Some virtual machines are configured for processing of storage inputs or outputs (I/O or IO) as received from any or every source within the computing platform. An example implementation of such a virtual machine that processes storage I/O is depicted as 830.

In this and other configurations, a controller virtual machine instance receives block I/O storage requests as network file system (NFS) requests in the form of NFS requests 802, and/or internet small computer system interface (iSCSI) block IO requests in the form of iSCSI requests 803, and/or Samba file system (SMB) requests in the form of SMB requests 804. The controller virtual machine (CVM) instance publishes and responds to an internet protocol (IP) address (e.g., CVM IP address 810). Various forms of input and output can be handled by one or more IO control (IOCTL) handler functions (e.g., IOCTL handler functions 808) that interface to other functions such as data IO manager functions 814 and/or metadata manager functions 822. As shown, the data IO manager functions can include communication with virtual disk configuration manager 812 and/or can include direct or indirect communication with any of various block IO functions (e.g., NFS IO, iSCSI IO, SMB IO, etc.).

In addition to block IO functions, configuration 851 supports input or output (IO) of any form (e.g., block IO, streaming IO) and/or packet-based IO such as hypertext transport protocol (HTTP) traffic, etc., through either or both of a user interface (UI) handler such as UI IO handler 840 and/or through any of a range of application programming interfaces (APIs), possibly through API IO manager 845.

Communications link 815 can be configured to transmit (e.g., send, receive, signal, etc.) any type of communications packets comprising any organization of data items. The data items can comprise a payload data, a destination address (e.g., a destination IP address) and a source address (e.g., a source IP address), and can include various packet processing techniques (e.g., tunneling), encodings (e.g., encryption), and/or formatting of bit fields into fixed-length blocks or into variable length fields used to populate the payload. In some cases, packet characteristics include a version identifier, a packet or payload length, a traffic class, a flow label, etc. In some cases, the payload comprises a data structure that is encoded and/or formatted to fit into byte or word boundaries of the packet.

In some embodiments, hard-wired circuitry may be used in place of, or in combination with, software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to a data processor for execution. Such a medium may take many forms including, but not limited to, non-volatile media and volatile media. Non-volatile media includes any non-volatile storage medium, for example, solid state storage devices (SSDs) or optical or magnetic disks such as hard disk drives (HDDs) or hybrid disk drives, or random access persistent memories (RAPMs) or optical or magnetic media drives such as paper tape or magnetic tape drives. Volatile media includes dynamic memory such as random access memory. As shown, controller virtual machine instance 830 includes content cache manager facility 816 that accesses storage locations, possibly including local dynamic random access memory (DRAM) (e.g., through local memory device access block 818) and/or possibly including accesses to local solid state storage (e.g., through local SSD device access block 820).

Common forms of computer readable media include any non-transitory computer readable medium, for example, floppy disk, flexible disk, hard disk, magnetic tape, or any other magnetic medium; compact disk read-only memory (CD-ROM) or any other optical medium; punch cards, paper tape, or any other physical medium with patterns of holes; or any random access memory (RAM), programmable read-only memory (PROM), erasable programmable read-only memory (EPROM), flash memory EPROM (FLASH-EPROM), or any other memory chip or cartridge. Any data can be stored, for example, in any form of data repository 831, which in turn can be formatted into any one or more storage areas, and which can comprise parameterized storage accessible by a key (e.g., a filename, a table name, a block address, an offset address, etc.). Data repository 831 can store any forms of data, and may comprise a storage area dedicated to storage of metadata pertaining to the stored forms of data. In some cases, metadata can be divided into portions. Such portions and/or cache copies can be stored in the storage data repository and/or in a local storage area (e.g., in local DRAM areas and/or in local SSD areas). Such local storage can be accessed using functions provided by local metadata storage access block 824. The data repository 831 can be configured using CVM virtual disk controller 826, which can in turn manage any number or any configuration of virtual disks.

Execution of a sequence of instructions to practice certain embodiments of the disclosure are performed by one or more instances of a software instruction processor, or a processing element such as a central processing unit (CPU) or data processor or graphics processing unit, or such as any type or instance of a processor (e.g., CPU1, CPU2, . . . , CPUN). According to certain embodiments of the disclosure, two or more instances of configuration 851 can be coupled by communications link 815 (e.g., backplane, local area network, public switched telephone network, wired or wireless network, etc.) and each instance may perform respective portions of sequences of instructions as may be required to practice embodiments of the disclosure.

The shown computing platform 806 is interconnected to the Internet 848 through one or more network interface ports (e.g., network interface port 823₁ and network interface port 823₂). Configuration 851 can be addressed through one or more network interface ports using an IP address. Any operational element within computing platform 806 can perform sending and receiving operations using any of a range of network protocols, possibly including network protocols that send and receive packets (e.g., network protocol packet 821₁ and network protocol packet 821₂).

Computing platform 806 may transmit and receive messages that can be composed of configuration data and/or any other forms of data and/or instructions organized into a data structure (e.g., communications packets). In some cases, the data structure includes program instructions (e.g., application code) communicated through the Internet 848 and/or through any one or more instances of communications link 815. Received program instructions may be processed and/or executed by a CPU as it is received and/or program instructions may be stored in any volatile or non-volatile storage for later execution. Program instructions can be transmitted via an upload (e.g., an upload from an access device over the Internet 848 to computing platform 806). Further, program instructions and/or the results of executing program instructions can be delivered to a particular user via a download (e.g., a download from computing platform 806 over the Internet 848 to an access device).

Configuration 851 is merely one sample configuration. Other configurations or partitions can include further data processors, and/or multiple communications interfaces, and/or multiple storage devices, etc. within a partition. For example, a partition can bound a multi-core processor (e.g., possibly including embedded or collocated memory), or a partition can bound a computing cluster having a plurality of computing elements, any of which computing elements are connected directly or indirectly to a communications link. A first partition can be configured to communicate to a second partition. A particular first partition and a particular second partition can be congruent (e.g., in a processing element array) or can be different (e.g., comprising disjoint sets of components).

A cluster is often embodied as a collection of computing nodes that can communicate between each other through a local area network (LAN) and/or through a virtual LAN (VLAN) and/or over a backplane. Some clusters are characterized by assignment of a particular set of the aforementioned computing nodes to access a shared storage facility that is also configured to communicate over the local area network or backplane. In many cases, the physical bounds of a cluster are defined by a mechanical structure such as a cabinet or such as a chassis or rack that hosts a finite number of mounted-in computing units. A computing unit in a rack can take on a role as a server, or as a storage unit, or as a networking unit, or any combination therefrom. In some cases, a unit in a rack is dedicated to provisioning of power to other units. In some cases, a unit in a rack is dedicated to environmental conditioning functions such as filtering and movement of air through the rack and/or temperature control for the rack. Racks can be combined to form larger clusters. For example, the LAN of a first rack having a quantity of 32 computing nodes can be interfaced with the LAN of a second rack having 16 nodes to form a two-rack cluster of 48 nodes. The former two LANs can be configured as subnets, or can be configured as one VLAN. Multiple clusters can communicate between one module to another over a WAN (e.g., when geographically distal) or a LAN (e.g., when geographically proximal).

As used herein, a module can be implemented using any mix of any portions of memory and any extent of hard-wired circuitry including hard-wired circuitry embodied as a data processor. Some embodiments of a module include one or more special-purpose hardware components (e.g., power control, logic, sensors, transducers, etc.). A data processor can be organized to execute a processing entity that is configured to execute as a single process or configured to execute using multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

Some embodiments of a module include instructions that are stored in a memory for execution so as to facilitate operational and/or performance characteristics pertaining to reconfiguring a replacement graphics processing unit in disaster recovery scenarios. In some embodiments, a module may include one or more state machines and/or combinational logic used to implement or facilitate the operational and/or performance characteristics pertaining to reconfiguring a replacement graphics processing unit in disaster recovery scenarios.

Various implementations of the data repository comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of reconfiguring a replacement graphics processing unit in disaster recovery scenarios). Such files or records can be brought into and/or stored in volatile or non-volatile memory.

Further details regarding general approaches to managing data repositories are described in U.S. Pat. No. 8,601,473 titled “ARCHITECTURE FOR MANAGING I/O AND STORAGE FOR A VIRTUALIZATION ENVIRONMENT” issued on Dec. 3, 2013, which is hereby incorporated by reference in its entirety.

Further details regarding general approaches to managing and maintaining data in data repositories are described in U.S. Pat. No. 8,549,518 titled “METHOD AND SYSTEM FOR IMPLEMENTING A MAINTENANCE SERVICE FOR MANAGING I/O AND STORAGE FOR A VIRTUALIZATION ENVIRONMENT” issued on Oct. 1, 2013, which is hereby incorporated by reference in its entirety.

FIG. 8B depicts a virtualized controller implemented by containerized architecture 8B00. The containerized architecture comprises a collection of interconnected components suitable for implementing embodiments of the present disclosure and/or for use in the herein-described environments. Moreover, the shown containerized architecture 8B00 includes an executable container instance in configuration 852 that is further described as pertaining to executable container instance 850. Configuration 852 includes an operating system layer (as shown) that performs addressing functions such as providing access to external requestors (e.g., user virtual machines or other processes) via an IP address (e.g., “P.Q.R.S”, as shown). Providing access to external requestors can include implementing all or portions of a protocol specification, possibly including the hypertext transport protocol (HTTP or “http:”) and/or possibly handling port-specific functions. In this and other embodiments, external requestors (e.g., user virtual machines or other processes) rely on the aforementioned addressing functions to access a virtualized controller for performing all data storage functions. Furthermore, when data input or output requests are received from a requestor running on a first node are received at the virtualized controller on that first node, then in the event that the requested data is located on a second node, the virtualized controller on the first node accesses the requested data by forwarding the request to the virtualized controller running at the second node. In some cases, a particular input or output request might be forwarded again (e.g., an additional or Nth time) to further nodes. As such, when responding to an input or output request, a first virtualized controller on the first node might communicate with a second virtualized controller on the second node, which second node has access to particular storage devices on the second node or, the virtualized controller on the first node may communicate directly with storage devices on the second node.

The operating system layer can perform port forwarding to any executable container (e.g., executable container instance 850). An executable container instance can be executed by a processor. Runnable portions of an executable container instance sometimes derive from an executable container image, which in turn might include all, or portions of any of, a Java archive repository (JAR) and/or its contents, and/or a script or scripts and/or a directory of scripts, and/or a virtual machine configuration, and may include any dependencies therefrom. In some cases, a configuration within an executable container might include an image comprising a minimum set of runnable code. Contents of larger libraries and/or code or data that would not be accessed during runtime of the executable container instance can be omitted from the larger library to form a smaller library composed of only the code or data that would be accessed during runtime of the executable container instance. In some cases, start-up time for an executable container instance can be much faster than start-up time for a virtual machine instance, at least inasmuch as the executable container image might be much smaller than a respective virtual machine instance. Furthermore, start-up time for an executable container instance can be much faster than start-up time for a virtual machine instance, at least inasmuch as the executable container image might have many fewer code and/or data initialization steps to perform than a respective virtual machine instance.

An executable container instance can serve as an instance of an application container or as a controller executable container. Any executable container of any sort can be rooted in a directory system and can be configured to be accessed by file system commands (e.g., “1 s”, “dir”, etc.). The executable container might optionally include operating system components 878, however such a separate set of operating system components need not be provided. As an alternative, an executable container can include runnable instance 858, which is built (e.g., through compilation and linking, or just-in-time compilation, etc.) to include any or all of any or all library entries and/or operating system (OS) functions, and/or OS-like functions as may be needed for execution of the runnable instance. In some cases, a runnable instance can be built with a virtual disk configuration manager, any of a variety of data IO management functions, etc. In some cases, a runnable instance includes code for, and access to, container virtual disk controller 876. Such a container virtual disk controller can perform any of the functions that the aforementioned CVM virtual disk controller 826 can perform, yet such a container virtual disk controller does not rely on a hypervisor or any particular operating system so as to perform its range of functions.

In some environments, multiple executable containers can be collocated and/or can share one or more contexts. For example, multiple executable containers that share access to a virtual disk can be assembled into a pod (e.g., a Kubernetes pod). Pods provide sharing mechanisms (e.g., when multiple executable containers are amalgamated into the scope of a pod) as well as isolation mechanisms (e.g., such that the namespace scope of one pod does not share the namespace scope of another pod).

FIG. 8C depicts a virtualized controller implemented by a daemon-assisted containerized architecture 8C00. The containerized architecture comprises a collection of interconnected components suitable for implementing embodiments of the present disclosure and/or for use in the herein-described environments. Moreover, the shown daemon-assisted containerized architecture includes a user executable container instance in configuration 853 that is further described as pertaining to user executable container instance 870. Configuration 853 includes a daemon layer (as shown) that performs certain functions of an operating system.

User executable container instance 870 comprises any number of user containerized functions (e.g., user containerized function1, user containerized function2, . . . , user containerized functionN). Such user containerized functions can execute autonomously or can be interfaced with or wrapped in a runnable object to create a runnable instance (e.g., runnable instance 858). In some cases, the shown operating system components 878 comprise portions of an operating system, which portions are interfaced with or included in the runnable instance and/or any user containerized functions. In this embodiment of a daemon-assisted containerized architecture, the computing platform 806 might or might not host operating system components other than operating system components 878. More specifically, the shown daemon might or might not host operating system components other than operating system components 878 of user executable container instance 870.

The virtual machine architecture 8A00 of FIG. 8A and/or the containerized architecture 8B00 of FIG. 8B and/or the daemon-assisted containerized architecture 8C00 of FIG. 8C can be used in any combination to implement a distributed platform that contains multiple servers and/or nodes that manage multiple tiers of storage where the tiers of storage might be formed using the shown data repository 831 and/or any forms of network accessible storage. As such, the multiple tiers of storage may include storage that is accessible over communications link 815. Such network accessible storage may include cloud storage or networked storage (NAS) and/or may include all or portions of a storage area network (SAN). Unlike prior approaches, the presently discussed embodiments permit local storage that is within or directly attached to the server or node to be managed as part of a storage pool. Such local storage can include any combinations of the aforementioned SSDs and/or HDDs and/or RAPMs and/or hybrid disk drives. The address spaces of a plurality of storage devices, including both local storage (e.g., using node-internal storage devices) and any forms of network-accessible storage, are collected to form a storage pool having a contiguous address space.

Significant performance advantages can be gained by allowing the virtualization system to access and utilize local (e.g., node-internal) storage. This is because I/O performance is typically much faster when performing access to local storage as compared to performing access to networked storage or cloud storage. This faster performance for locally attached storage can be increased even further by using certain types of optimized local storage devices such as SSDs or RAPMs, or hybrid HDDs, or other types of high-performance storage devices.

In example embodiments, each storage controller exports one or more block devices or NFS or iSCSI targets that appear as disks to user virtual machines or user executable containers. These disks are virtual since they are implemented by the software running inside the storage controllers. Thus, to the user virtual machines or user executable containers, the storage controllers appear to be exporting a clustered storage appliance that contains some disks. User data (including operating system components) in the user virtual machines resides on these virtual disks.

Any one or more of the aforementioned virtual disks (or “vDisks”) can be structured from any one or more of the storage devices in the storage pool. As used herein, the term “vDisk” refers to a storage abstraction that is exposed by a controller virtual machine or container to be used by another virtual machine or container. In some embodiments, the vDisk is exposed by operation of a storage protocol such as iSCSI or NFS or SMB. In some embodiments, a vDisk is mountable. In some embodiments, a vDisk is mounted as a virtual storage device.

In example embodiments, some or all of the servers or nodes run virtualization software. Such virtualization software might include a hypervisor (e.g., as shown in configuration 851 of FIG. 8A) to manage the interactions between the underlying hardware and user virtual machines or containers that run client software.

Distinct from user virtual machines or user executable containers, a special controller virtual machine (e.g., as depicted by controller virtual machine instance 830) or as a special controller executable container is used to manage certain storage and I/O activities. Such a special controller virtual machine is referred to as a “CVM”, or as a controller executable container, or as a service virtual machine (SVM), or as a service executable container, or as a storage controller. In some embodiments, multiple storage controllers are hosted by multiple nodes. Such storage controllers coordinate within a computing system to form a computing cluster.

The storage controllers are not formed as part of specific implementations of hypervisors. Instead, the storage controllers run above hypervisors on the various nodes and work together to form a distributed system that manages all of the storage resources, including the locally attached storage, the networked storage, and the cloud storage. In example embodiments, the storage controllers run as special virtual machines—above the hypervisors—thus, the approach of using such special virtual machines can be used and implemented within any virtual machine architecture. Furthermore, the storage controllers can be used in conjunction with any hypervisor from any virtualization vendor and/or implemented using any combinations or variations of the aforementioned executable containers in conjunction with any host operating system components.

FIG. 8D depicts a distributed virtualization system in a multi-cluster environment 8D00. The shown distributed virtualization system is configured to be used to implement the herein disclosed techniques. Specifically, the distributed virtualization system of FIG. 8D comprises multiple clusters (e.g., cluster 883₁, . . . , cluster 883_{N}) comprising multiple nodes that have multiple tiers of storage in a storage pool. Representative nodes (e.g., node 881₁₁, . . . , node 881_{1M}) and storage pool 890 associated with cluster 883₁ are shown. Each node can be associated with one server, multiple servers, or portions of a server. The nodes can be associated (e.g., logically and/or physically) with the clusters. As shown, the multiple tiers of storage include storage that is accessible through a network 896, such as a networked storage 886 (e.g., a storage area network or SAN, network attached storage or NAS, etc.). The multiple tiers of storage further include instances of local storage (e.g., local storage 891₁₁, . . . , local storage 891_{1M}). For example, the local storage can be within or directly attached to a server and/or appliance associated with the nodes. Such local storage can include solid state drives (SSD 893₁₁, . . . , SSD 893_{1M}), hard disk drives (HDD 894₁₁, . . . , HDD 894_{1M}), and/or other storage devices.

As shown, any of the nodes of the distributed virtualization system can implement one or more user virtualized entities (VEs) such as the virtualized entity (VE) instances shown as VE 888₁₁₁, . . . , VE 888_{11K}, . . . , VE 888_{1M1}, . . . , VE 888_{1MK}, and/or a distributed virtualization system can implement one or more virtualized entities that may be embodied as a virtual machines (VM) and/or as an executable container. The VEs can be characterized as software-based computing “machines” implemented in a container-based or hypervisor-assisted virtualization environment that emulates underlying hardware resources (e.g., CPU, memory, etc.) of the nodes. For example, multiple VMs can operate on one physical machine (e.g., node host computer) running a single host operating system (e.g., host operating system 887₁₁, . . . , host operating system 887_{1M}), while the VMs run multiple applications on various respective guest operating systems. Such flexibility can be facilitated at least in part by a hypervisor (e.g., hypervisor 885₁₁, . . . , hypervisor 885_{1M}), which hypervisor is logically located between the various guest operating systems of the VMs and the host operating system of the physical infrastructure (e.g., node).

As an alternative, executable containers may be implemented at the nodes in an operating system-based virtualization environment or in a containerized virtualization environment. The executable containers comprise groups of processes and/or may use resources (e.g., memory, CPU, disk, etc.) that are isolated from the node host computer and other containers. Such executable containers directly interface with the kernel of the host operating system (e.g., host operating system 887₁₁, . . . , host operating system 887_{1M}) without, in most cases, a hypervisor layer. This lightweight implementation can facilitate efficient distribution of certain software components, such as applications or services (e.g., micro-services). Any node of a distributed virtualization system can implement both a hypervisor-assisted virtualization environment and a container virtualization environment for various purposes. Also, any node of a distributed virtualization system can implement any one or more types of the foregoing virtualized controllers so as to facilitate access to storage pool 890 by the VMs and/or the executable containers.

Multiple instances of such virtualized controllers can coordinate within a cluster to form the distributed storage system 892 which can, among other operations, manage the storage pool 890. This architecture further facilitates efficient scaling in multiple dimensions (e.g., in a dimension of computing power, in a dimension of storage space, in a dimension of network bandwidth, etc.).

A particularly configured instance of a virtual machine at a given node can be used as a virtualized controller in a hypervisor-assisted virtualization environment to manage storage and I/O (input/output or IO) activities of any number or form of virtualized entities. For example, the virtualized entities at node 881₁₁ can interface with a controller virtual machine (e.g., virtualized controller 882₁₁) through hypervisor 885₁₁ to access data of storage pool 890. In such cases, the controller virtual machine is not formed as part of specific implementations of a given hypervisor. Instead, the controller virtual machine can run as a virtual machine above the hypervisor at the various node host computers. When the controller virtual machines run above the hypervisors, varying virtual machine architectures and/or hypervisors can operate with the distributed storage system 892. For example, a hypervisor at one node in the distributed storage system 892 might correspond to software from a first vendor, and a hypervisor at another node in the distributed storage system 892 might correspond to a second software vendor. As another virtualized controller implementation example, executable containers can be used to implement a virtualized controller (e.g., virtualized controller 882_{1M}) in an operating system virtualization environment at a given node. In this case, for example, the virtualized entities at node 881_{1M} can access the storage pool 890 by interfacing with a controller container (e.g., virtualized controller 882_{1M}) through hypervisor 885_{1M} and/or the kernel of host operating system 887_{1M}.

In certain embodiments, one or more instances of an agent can be implemented in the distributed storage system 892 to facilitate the herein disclosed techniques. Specifically, agent 884₁₁ can be implemented in the virtualized controller 882₁₁, and agent 884_{1M} can be implemented in the virtualized controller 882_{1M}. Such instances of the virtualized controller can be implemented in any node in any cluster. Actions taken by one or more instances of the virtualized controller can apply to a node (or between nodes), and/or to a cluster (or between clusters), and/or between any resources or subsystems accessible by the virtualized controller or their agents.

Solutions attendant to dynamically reconfiguring a replacement graphics processing unit when restarting on a recovery node can be brought to bear through implementation of any one or more of the foregoing techniques. Moreover, any aspect or aspects of providing high availability of a clustered virtualization system even when specialized GPUs are demanded by components of the to-be-restarted virtualization system can be implemented in the context of the foregoing environments.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

What is claimed is:

1. A non-transitory computer readable medium having stored thereon a sequence of instructions which, when stored in memory and executed by a processor cause the processor to perform acts comprising:
executing, on a first node of a computing cluster, a first instance of a computing process that is configured to use a first graphics processing unit (GPU) in a first GPU configuration;
detecting a loss of functionality that affects the computing process; and
responsive to detecting the loss of functionality, automatically determining that a second instance of the computing process can execute on a second node by:
determining that the second instance of the computing process can execute using a second GPU in a second GPU configuration on the second node; and
configuring the second instance of the computing process to use the second GPU in the second GPU configuration on the second node,
wherein the second GPU configuration is different from the first GPU configuration; and
wherein the second GPU configuration is based on at least one known configuration state.

2. The non-transitory computer readable medium of claim 1, further comprising instructions which, when stored in memory and executed by the processor cause the processor to perform further acts of determining that the computing process can run using a second GPU configuration comprises retrieving a recommendation from a machine learned model.

3. The non-transitory computer readable medium of claim 2, wherein the recommendation from the machine learned model involves an upward compatibility from the first GPU configuration to the second GPU configuration.

4. The non-transitory computer readable medium of claim 2, wherein the recommendation from the machine learned model involves a downward compatibility from the first GPU configuration to the second GPU configuration.

5. The non-transitory computer readable medium of claim 1, further comprising instructions which, when stored in memory and executed by the processor cause the processor to perform further acts of determining that the computing process can run using a second GPU configuration comprises retrieving at least one prediction from a machine learned model.

6. The non-transitory computer readable medium of claim 5, wherein the prediction from the machine learned model involves a memory size pertaining to the second GPU configuration.

7. The non-transitory computer readable medium of claim 1, further comprising instructions which, when stored in memory and executed by the processor cause the processor to perform further acts of probing a cloud-based infrastructure for available GPU configurations.

8. The non-transitory computer readable medium of claim 1, further comprising instructions which, when stored in memory and executed by the processor cause the processor to perform further acts of presenting, on a computer display screen, a graphical user interface (GUI) that depicts at least a portion of the second GPU configuration in the GUI.

9. A method comprising:
executing, on a first node of a computing cluster, a first instance of a computing process that is configured to use a first graphics processing unit (GPU) in a first GPU configuration;
detecting a loss of functionality that affects the computing process; and
responsive to detecting the loss of functionality, automatically determining that a second instance of the computing process can execute on a second node by:
determining that the second instance of the computing process can execute using a second GPU in a second GPU configuration on the second node; and
configuring the second instance of the computing process to use the second GPU in the second GPU configuration on the second node,
wherein the second GPU configuration is different from the first GPU configuration; and
wherein the second GPU configuration is based on at least one known configuration state.

10. The method of claim 9, further comprising determining that the computing process can run using a second GPU configuration comprises retrieving a recommendation from a machine learned model.

11. The method of claim 10, wherein the recommendation from the machine learned model involves an upward compatibility from the first GPU configuration to the second GPU configuration.

12. The method of claim 10, wherein the recommendation from the machine learned model involves a downward compatibility from the first GPU configuration to the second GPU configuration.

13. The method of claim 9, further comprising determining that the computing process can run using a second GPU configuration comprises retrieving at least one prediction from a machine learned model.

14. The method of claim 13, wherein the prediction from the machine learned model involves a memory size pertaining to the second GPU configuration.

15. The method of claim 9, further comprising probing a cloud-based infrastructure for available GPU configurations.

16. The method of claim 9, further comprising presenting, on a computer display screen, a graphical user interface (GUI) that depicts at least a portion of the second GPU configuration in the GUI.

17. A system comprising:
a storage medium having stored thereon a sequence of instructions; and
a processor that executes the sequence of instructions to cause the processor to perform acts comprising,
executing, on a first node of a computing cluster, a first instance of a computing process that is configured to use a first graphics processing unit (GPU) in a first GPU configuration;
detecting a loss of functionality that affects the computing process; and
responsive to detecting the loss of functionality, automatically determining that a second instance of the computing process can execute on a second node by:
determining that the second instance of the computing process can execute using a second GPU in a second GPU configuration on the second node; and
configuring the second instance of the computing process to use the second GPU in the second GPU configuration on the second node,
wherein the second GPU configuration is different from the first GPU configuration; and
wherein the second GPU configuration is based on at least one known configuration state.

18. The system of claim 17, further comprising instructions which, when stored in memory and executed by the processor cause the processor to perform further acts of determining that the computing process can run using a second GPU configuration comprises retrieving a recommendation from a machine learned model.

19. The system of claim 18, wherein the recommendation from the machine learned model involves an upward compatibility from the first GPU configuration to the second GPU configuration.

20. The system of claim 18, wherein the recommendation from the machine learned model involves a downward compatibility from the first GPU configuration to the second GPU configuration.

21. The system of claim 17, further comprising instructions which, when stored in memory and executed by the processor cause the processor to perform further acts of determining that the computing process can run using a second GPU configuration comprises retrieving at least one prediction from a machine learned model.

22. The system of claim 21, wherein the prediction from the machine learned model involves a memory size pertaining to the second GPU configuration.

23. The system of claim 17, further comprising instructions which, when stored in memory and executed by the processor cause the processor to perform further acts of probing a cloud-based infrastructure for available GPU configurations.

24. The system of claim 17, further comprising instructions which, when stored in memory and executed by the processor cause the processor to perform further acts of presenting, on a computer display screen, a graphical user interface (GUI) that depicts at least a portion of the second GPU configuration in the GUI.
